(19) United States
(12) Patent Application Publication
(10) Pub. No.: US 2008/0091459 A1
(43) Pub. Date: Apr. 17, 2008

(54) TRANSACTION CARD DESIGN MANAGEMENT SYSTEM

(75) Inventors: Tom Elgar, London (GB); Adam Elgar, Brooklyn, NY (US); Iain James Wishart McNeill, London (GB); Andrew Christian Camargo Francis, London (GB); Andrew Arnold Cox, London (GB)

Correspondence Address: MCDERMOTT WILL & EMERY LLP, 18191 VON KARMAN AVE., SUITE 500, IRVINE, CA, 92612-7108, US

(73) Assignee: Serverside Group Limited, London (GB)

(21) Appl. No.: 11/874,142

(22) Filed: Oct. 17, 2007

Related U.S. Application Data
(60) Provisional application No. 60/901,918, filed on Feb. 16, 2007.
(60) Provisional application No. 60/852,506, filed on Oct. 17, 2006.

(51) Int. Cl. G06Q 99/00

(52) U.S. Cl. 705/1

(57) ABSTRACT

A transaction card design creation apparatus comprising: a processor for generating a first user interface configured to enable creation of a product type transaction card design for application to a transaction card, and storing the product type transaction card design in a first storage device; and a processor for generating a second user interface configured to enable creation of a transaction card design comprising the product type transaction card design and at least one image, and storing the transaction card design in a second storage device.

### FIELD

The invention relates to the field of transaction card production, specifically methods and apparatus for the management of transaction card designs intended to be laid down by a digital printer or press or the like.

### BACKGROUND

Aspects of card design management have been addressed in WO 05/081128, incorporated herein by reference, and in commercially available printing and print management systems such as Artista and VHD module in MX6000 from Datacard.

To date, the vast majority of payment cards have been printed on a traditional or non-digital press at the time of manufacture, typically in batches of identical designs which are then shipped to the point of printing where unique customer information is added (embossed name and number, magnetic stripe information etc). However, more recently there have been great steps in the use of both digital printers and digital presses that enable an individual design to be laid down on a card and then sent out directly to the recipient.

One method of personalizing cards is that a set of customer (user) details (a set of embossing records) for a particular card design (such as Visa Classic) are batched together and delivered to a printing machine. Un-personalized cards of a particular card design are then placed in a hopper and the customer details added to the card before mailing.

The current management systems for the digital card printers are typically extensions of this approach where a card design is printed multiple times using an image called from a local database based on a set of records received from the Card Issuer (as embossing files). The card type is usually denoted by a field within this embossing record.

One system enables limitless card designs and even personalization of card designs by the card holder (see WO 04/074961, all of which is incorporated herein by reference).

However in these systems, the management and control of the card design portfolio is in two places:
With the Card Issuer Facility—which define what the card looks like with reference to Card Association (e.g. Visa/MasterCard etc.) guidelines and the limitations of the Card Personalisation (printing) Facility; and
With the Card Personalisation (printing) Facility—which is concerned with the production and delivery of the card design to the customer (user).

These facilities are typically separated geographically and frequently are from separate companies. Indeed there is usually a great deal of separation even within the Card Issuer facility and usually there is not a defined electronic process for passing these images between the various groups. Often this leads to face to face meetings to agree sign-off, which results in process delays.

The result is that the Card Issuer Facility is unable to make changes to the card design without contacting the Card Personalisation (printing) Facility and requesting a change. There is also a danger that the change is made incorrectly. This has the result of constraining the choices made available to the customer (user). Furthermore this process typically takes eight weeks and can take many months.

FIG. 1 represents the prior art mechanism by which card designs are printed to date. The key issues here are that the card designs represented to the new or existing customer (user) 1 are requested and served 3 from a first database 4 controlled by the Card Issuer 2. The user's card design choice is communicated by the data sent 5 from the Card Issuer 2 to the Personalization Facility 6. When the card is printed an image for the selected card design is requested and served 7 from a second database 8 at the Card Personalization Facility 6. This second database 8 would in practice be a storage device storing a collection of cards pre-printed with the card design. Since the first database 4 and the second database 8 are not connected directly there is a possibility that the images corresponding to the same card design are different or that one is missing entirely. The separation of these aspects has caused management of the card stocks to be an expensive and labour-intensive process with many points of logistical failure.

Furthermore, whilst there is a reporting channel feeding back to the Card Issuer 2, the information about cards produced is not centralized making analysis more difficult.

Moreover, the second database 8 and collection of cards are on-site. This means there are significant disaster recovery risks since all records and all card templates could be lost without backup (or are held at great expensive at an off-site facility).

The present invention seeks to provide an improved card design management system.

### SUMMARY

In one embodiment of the invention a design data packet defining a transaction card design stored on a computer readable medium is provided. The design data packet comprising: an unique product type identifier; and an unique card design identifier.

In one embodiment of the invention a computer program product comprising computer program code in the form of a design data packet defining a transaction card design stored on a computer readable medium is provided. The design data packet comprising: an unique product type identifier; and an unique card design identifier.

In another embodiment the design data packet further comprises: an unique transaction card design identifier.

In another embodiment the transaction card design identifier is associated with an user defined transaction card design identifier, such that the user defined transaction card design identifier references the transaction card design identifier.

In another embodiment the transaction card design identifier is replaced with an user defined transaction card design identifier.

In another embodiment the product type identifier is associated with product type image data.

In another embodiment the product type identifier comprises product type image data.

In another embodiment the product type identifier is associated with product type data and product type manipulation data defining manipulations to be applied to the transaction card design.

In another embodiment the product type identifier comprises product type data and product type manipulation data defining manipulations to be applied to the transaction card design.

In another embodiment the card design identifier is associated with image data and image manipulation data defining manipulations to be applied to the image.

In another embodiment the card design identifier comprises image data and image manipulation data defining manipulations to be applied to the image.

In another embodiment the product type data comprises first product type data for application to a first surface of a transaction card and second product type data for application to a second surface of the transaction card, and the product type manipulation data comprises first product type manipulation data for application to a first surface of the transaction card and second product type manipulation data for application to a second surface of the transaction card.

In another embodiment the image data comprises first image data for application to a first surface of a transaction card and second image data for application to a second surface of the transaction card, and the image manipulation data comprises first image manipulation data for application to a first surface of the transaction card and second image manipulation data for application to a second surface of the transaction card.

In another embodiment the image data comprises an image.

In another embodiment the image data comprises an unique image identifier associated with an image stored in a storage device.

In another embodiment the product type data overlays the image data.

In another embodiment the product type data is contained within a transparent layer.

In another embodiment the product type manipulation data comprises information regarding relative position; scale; orientation; opacity; pigments; inks; spot colours and/or metallic inks, tipping colours; BIN legends; coatings; text; text font size; text alphabet; text leading; text weighting; text spacing; text colour; and/or text position to be applied to the transaction card design.

In another embodiment the product type manipulation data is provided within the product type data.

In another embodiment the product type manipulation data is provided in a separate but related file from the product type data.

In another embodiment the image manipulations data comprises information regarding relative position; scale; orientation; text; opacity; pigments; inks; spot colours and/or metallic inks to be applied to the image.

In another embodiment the image manipulation data is provided within the image data.

In another embodiment the image manipulation data is provided in a separate but related file from the image data.

In one embodiment a design data packet defining a transaction card product type stored on a computer readable medium is provided. The design data packet comprising: an unique product type identifier; product type data; and product type manipulation data defining manipulations to be applied to the transaction card design.

In one embodiment a computer program product comprising computer program code in the form of a design data packet defining a transaction card product type stored on a computer readable medium is provided. The design data packet comprising: an unique product type identifier; product type data; and product type manipulation data defining manipulations to be applied to the transaction card design.

In one embodiment an apparatus for generating a compiled transaction card design comprising: a processor for generating a compiled transaction card design in one or more formats in accordance with the design data packet; and an output for outputting the compiled transaction card design in one or more formats is provided.

In another embodiment the apparatus further comprises: one or more storage devices for storing the compiled transaction card design in one or more formats.

In another embodiment amendment of the design data packet result in amendment of the compiled transaction card design.

In another embodiment the transaction card design identifier is provided within a link of the compiled transaction card design.

In one embodiment a transaction card design creation apparatus is provided. The apparatus comprising: a processor for generating a first user interface configured to enable creation of a product type transaction card design for application to a transaction card, and storing the product type transaction card design in a first storage device; and a processor for generating a second user interface configured to enable creation of a transaction card design comprising the product type transaction card design and at least one image, and storing the transaction card design in a second storage device.

In another embodiment the product type transaction card design comprises a first product type transaction card design for application to a first surface of the transaction card and a second product type transaction card design for application to a second surface of the transaction card.

In another embodiment an unique product type transaction card design identifier is associated with the product type transaction card design.

In another embodiment the first user interface is configured to enable amendment of the product type transaction card design, and wherein the amended product type transaction card design is associated with the unique product type transaction card design identifier.

In another embodiment the first storage device comprises a plurality of product type transaction card designs, and wherein the second user interface is configured to enable selection of one of the plurality of product type transaction card designs.

In another embodiment the first storage device and the second storage device are the same storage device.

In another embodiment the product type transaction card design comprises: product type manipulation data defining manipulations to be applied to the transaction card design.

In another embodiment the product type transaction card design further comprises: product type image data.

In another embodiment the transaction card manipulation data comprises information regarding at least one of the following: relative position; scale; orientation; opacity; pigments; inks; spot colours; metallic inks; tipping colours; BIN legends; coatings; text; text font size; text alphabet; text leading; text weighting; text spacing; text colour; and/or text position to be applied to the transaction card design.

In another embodiment the second user interface comprises an image store and the image is uploaded to the image store.

In another embodiment the second user interface comprises an image store and the image is selected from a plurality of images held in the image store.

In another embodiment the image further comprises: image manipulations data defining manipulations applied to the image.

In another embodiment the image manipulations data comprises information regarding relative position; scale; orientation; text; opacity; pigments; inks; spot colours and/or metallic inks to be applied to the image.

In another embodiment the apparatus further comprises: a processor for generating a card personalisation facility interface configured to transfers the transaction card design from the second storage device to a card personalisation facility for printing onto a transaction card.

In another embodiment the apparatus further comprises: a transaction card design generator for generating a compiled transaction card design in one or more formats, based on the transaction card design.

In another embodiment the one or more formats of the compiled transaction card design is stored in a compiled transaction card design storage device.

In one embodiment a method of creating a transaction card design is provided. The method comprising: generating a first user interface configured to enable creation of a product type transaction card design for application to a transaction card, and storing the product type transaction card design in a first storage device; and generating a second user interface configured to enable creation of a transaction card design comprising the product type transaction card design and at least one image, and storing the transaction card design in a second storage device.

In one embodiment a computer program product comprising program code means is provided. The program code means configured to cause a computer to perform the following steps: generate a first user interface configured to enable creation of a product type transaction card design for application to a transaction card, and storing the product type transaction card design in a first storage device; and generate a second user interface configured to enable creation of a transaction card design comprising the product type transaction card design and at least one image, and storing the transaction card design in a second storage device.

In one embodiment a computer readable medium comprising computer readable code is provided. The computer readable code configured to cause a computer to perform the following steps: generate a first user interface configured to enable creation of a product type transaction card design for application to a transaction card, and storing the product type transaction card design in a first storage device; and generate a second user interface configured to enable creation of a transaction card design comprising the product type transaction card design and at least one image, and storing the transaction card design in a second storage device.

In one embodiment a transaction card production apparatus is provided. The apparatus comprising: a processor for generating a first user interface configured to enable creation of a plurality of transaction card designs, and storing the transaction card designs in a storage device; a processor for generating a second user interface configured to enable selection of a transaction card design from the plurality of transaction card designs, and associating the selected transaction card design with user information; and a processor for generating a card personalisation facility interface configured to transfer the selected transaction card design and associated user information to a card personalisation facility for printing on a transaction card.

In another embodiment each of the plurality of transaction card designs is associated with an unique transaction card design identifier, wherein the second user interface is configured to enable association of the selected transaction card design identifier with the user information, and wherein the card personalisation facility interface is configured to transfer the transaction card design identifier and associated user information to a card personalisation facility, and retrieve the selected transaction card design from the storage device based on the transaction card design identifier for printing on a transaction card.

In one embodiment a transaction card production apparatus is provided. The apparatus comprising: a processor for generating a first user interface configured to enable creation of a plurality of transaction card designs, and storing the plurality of transaction card designs in a storage device, each of the plurality of transaction card designs associated with an unique transaction card design identifier; a processor for generating a second user interface configured to enable selection of a transaction card design from the plurality of transaction card designs, for associating the selected transaction card design identifier with an unique user identifier, and for associating the user identifier with user information; and a processor for generating a card personalisation facility interface configured to transfer the unique user identifier and associated user information to the card personalisation facility, and retrieve the selected transaction card design from the storage device based on the unique user identifier, for printing on a transaction card.

In one embodiment, an apparatus for printing a transaction card design onto a transaction card is provided. The apparatus comprising: a first database comprising a plurality of transaction card designs; an internet communication link connecting the first database to a second database held in a secure environment, the second database comprising the plurality of transaction card designs, such that when a transaction card design is amended in the first database, the corresponding transaction card design is amended in the second database; and a card personalisation facility interface configured to transfer a transaction card design from the second storage device to a card personalisation facility for printing onto a transaction card.

In another embodiment the card personalisation facility interface is configured to transfer printer data from the card personalisation facility to the second storage device.

In another embodiment the printer data comprise information regarding the number of transaction cards printed, the number of each transaction card design printed and/or the number of blank transaction cards available.

In another embodiment the card personalisation facility interface is configured to transfer alert data from the card personalisation facility to the second storage device when the number of blank transaction cards falls below a predetermined value.

In another embodiment the data is transferred from the second database to the first database via the internet communications link.

In one embodiment a transaction card design apparatus is provided. The apparatus comprising: a first storage device storing a transaction card design for application to a transaction card; and a second storage device storing contents which replicate at least a portion of the contents of the first database, wherein the first and second storage device have a master and slave relationship, and the first database is the master.

In one embodiment a transaction card design creation apparatus is provided. The apparatus comprising: a processor for generating a first user interface configured to enable creation of a product type transaction card design for application to a transaction card, and storing the product type transaction card design in a storage device; and a processor for generating a card personalisation facility interface configured to transfer the product type transaction card design from the storage device to a card personalisation facility for printing onto a transaction card.

In another embodiment the product type transaction card design comprises a first product type transaction card design for application to a first surface of the transaction card and a second product type transaction card design for application to a second surface of the transaction card.

In another embodiment an unique product type transaction card design identifier is associated with the product type transaction card design.

In another embodiment the first user interface is configured to enable amendment of the product type transaction card design, and wherein the amended product type transaction card design is associated with the unique product type transaction card design identifier.

In another embodiment the product type transaction card design comprises: product type manipulation data defining manipulations to be applied to the transaction card design.

In another embodiment the product type transaction card design further comprises: product type image data.

In another embodiment the transaction card manipulation data comprises information regarding at least one of the following: relative position; scale; orientation; opacity; pigments; inks; spot colours; metallic inks; tipping colours; BIN legends; coatings; text; text font size; text alphabet; text leading; text weighting; text spacing; text colour; and/or text position to be applied to the transaction card design.

In another embodiment the apparatus further comprises: a product type transaction card design generator for generating a compiled product type transaction card design in one or more formats, based on the product type transaction card design.

In another embodiment the one or more formats of the compiled product type transaction card design is stored in a compiled product type transaction card design storage device.

In one embodiment a method for creating a transaction card comprising a product type transaction card design is provided. The method comprising: generating a first user interface configured to enable creation of a product type transaction card design for application to a transaction card; storing the product type transaction card design in a storage device; and generating a card personalisation facility interface configured to transfer the product type transaction card design from the storage device to a card personalisation facility for printing onto a transaction card.

In one embodiment a computer program product comprising program code means is provided. The program code means configured to cause a computer to perform the following steps: generating a first user interface configured to enable creation of a product type transaction card design for application to a transaction card; storing the product type transaction card design in a storage device; and generating a card personalisation facility interface configured to transfer the product type transaction card design from the storage device to a card personalisation facility for printing onto a transaction card.

In one embodiment a computer readable medium comprising computer readable code is provided. The computer readable code configured to cause a computer to perform the following steps: generating a first user interface configured to enable creation of a product type transaction card design for application to a transaction card; storing the product type transaction card design in a storage device; and generating a card personalisation facility interface configured to transfer the product type transaction card design from the storage device to a card personalisation facility for printing onto a transaction card.

In one embodiment an apparatus for producing a personalised transaction card is provided. The apparatus comprising: a processor for generating a card design interface configured to enable a user to select a image from a plurality of images, each image associated with an unique image identifier, select a transaction card product type from a plurality of transaction card product types, each transaction card product type associated with an unique transaction card product type identifier; a processor for generating a card issuer interface configured to receive the selected transaction card image identifier and the selected transaction card product type identifier from the card design interface, and to associate user data with the selected transaction card image identifier and the selected transaction card product type identifier; a processor for generating a card personalisation facility interface configured to receive the user data from the card issuer interface, obtain a transaction card associated with the selected transaction card product type identifier from a secure area, and retrieve the selected transaction card image associated with the selected transaction card image identifier from a transaction card image storage device for printing on the transaction card.

In another embodiment the personalisation facility comprises the transaction card image storage device, and the transaction card image is transferred from the card design interface to a transaction card image storage device.

In another embodiment the transaction card image storage device is held in a secure area

In one embodiment a method of producing a transaction card is provided. The method comprising: selecting a transaction card image from a plurality of transaction card images, each transaction card image associated with an unique transaction card image identifier, selecting a transaction card product type from a plurality of transaction card product types, each transaction card product type associated with an unique transaction card product type identifier, and associating the selected transaction card image identifier with the selected transaction card product type identifier; transferring the selected transaction card image identifier and the associated selected transaction card product type identifier to a card issuer; transferring the selected transaction card image identifier and the associated selected transaction card product type identifier together with user data to a card personalisation facility; retrieving the selected transaction card image associated with the selected transaction card image identifier from a transaction card image storage device; obtaining a transaction card associated with the selected transaction card product type identifier from a secure area; and printing the selected transaction card image and the user data onto the transaction card.

In one embodiment an apparatus for producing a personalised transaction card is provided. The apparatus comprising: processor for generating a card design interface configured to enable a user to select a transaction card image from a plurality of transaction card images, each transaction card image associated with an unique transaction card image identifier, select a transaction card product type from a plurality of transaction card product types, each transaction card product type associated with an unique transaction card product type identifier, and associate the selected transaction card image identifier with the selected transaction card product type identifier; a processor for generating a card issuer interface configured to receive the selected transaction card image identifier from the card design interface, and to associate user data with the selected transaction card image identifier; a processor for generating a card personalisation facility interface configured to receive the user data from the card issuer interface, retrieve the selected transaction card image associated with the selected transaction card image identifier from a transaction card image storage device, and obtain a transaction card associated with the selected transaction card product type identifier from a secure area for printing on the transaction card.

In another embodiment the personalisation facility comprises the transaction card image storage device, and the transaction card image is transferred from the card design interface to a transaction card image storage device.

In another embodiment the transaction card image storage device is held in a secure area

In one embodiment a method of producing a personalised transaction card is provided. The method comprising: selecting a transaction card image from a plurality of transaction card images, each transaction card image associated with an unique transaction card image identifier, selecting a transaction card product type from a plurality of transaction card product types, each transaction card product type associated with an unique transaction card product type identifier, and associating the selected transaction card image identifier with the selected transaction card product type identifier; transferring the selected transaction card image identifier to a transaction card issuer; associating the selected transaction card image identifier with user data, and transferring the user data to a transaction card personalisation facility; retrieving the selected transaction card image associated with the selected transaction card image identifier from a transaction card image storage device; obtaining a transaction card associated with the selected transaction card product type identifier from a secure area; and printing the selected transaction card image and the user data onto the transaction card.

In one embodiment a method for creating a transaction card design for application to a transaction card is provided. The method comprising: providing a first user with access to an administration interface, and enabling the first user to create and/or edit a transaction card design and submit the created and/or edited transaction card design for approval; providing at least one second user with access to the administration interface, and enabling the second user to approve or reject the created and/or edited transaction card design; and providing a third user with access to the administration interface, and enabling the third user to release the approved transaction card design for application to a transaction card.

In another embodiment submission of the created and/or edited transaction card design by the first user results in a message being sent to the at least one second user.

In another embodiment the second user is informed that the created and/or edited transaction card design is awaiting approval/rejection when the second users accesses the administration interface.

In another embodiment the method further comprises: enabling the second user to see the history of edits performed on the transaction card design.

In another embodiment the second user rejects the created and/or edited transaction card design, and the method further comprises: enabling the second user to compile a message explaining why the created and/or edited transaction card design has been rejected

In another embodiment the message is provided to the first user.

In another embodiment if all of the at least one second users approve the created and/or edited transaction card design, then a message is sent to the third user.

In one embodiment an apparatus creating a transaction card design is provided. The apparatus comprising: a processor for generating a first user interface configured to enable selection of a product type transaction card design from a plurality of product type transaction card designs and application of at least one image to the selected product type transaction card design to create a transaction card design, for storing the transaction card design in a storage device, and for associating text with transaction card design; and a processor for generating a document comprising the transaction card design and the associated text.

In another embodiment the processor for generating the document is capable of generating the document in one or more formats.

In another embodiment the document comprises of a web page.

In another embodiment the document comprises a transaction card application form.

In one embodiment a method for creating a transaction card design for application to a transaction card is provided. The method comprising: generating a first user interface configured to enable selection of a product type transaction card design from a plurality of product type transaction card designs and application of at least one image to the selected product type transaction card design to create a transaction card design, for storing the transaction card design in a storage device, and for associating text with transaction card design; and generating a document comprising the transaction card design and the associated text.

An advantage of the system of the invention is that it enables the financial card issuer or affinity marketing team to add, remove and make changes to card designs directly from their desktop. This is done by enabling them to adjust the actual digital images that will be printed through the internet or other computer network. In addition, both the Card Issuer and the Card Personalization Facility retrieve card designs from the same database.

Another advantage of the system over prior art is that it removes the possibility of duplicate, incorrect or missing images. This is a significant improvement since it enables an administrator (typically of the Card Issuer) to make changes to the cards on offer directly and without needing to communicate through other channels with the Card Personalization Facility.

The operational advantages of this change are that limitless new card choices can be made available to a huge array of potential co-brand, affinity and other partner card portfolios without the need for the labour-intensive checks and balances which are expensive and rapidly become overwhelming in a large Card Issuer.

An additional benefit of the invention is that incorrect or outdated card designs can be updated on marketing materials and cards produced simultaneously in real time.

### DESCRIPTION OF THE DRAWINGS

For a better understanding of the present invention and to show how the same may be carried into effect, reference will now be made by way of example to the accompanying drawings:

FIG. 1 illustrates a prior art process and apparatus by which transaction cards are printed;

FIG. 2 illustrates a process and apparatus by which transaction cards are printed according to the present invention;

FIG. 3 illustrates another process and apparatus by which transaction cards are printed according to the present invention;

FIG. 4 illustrates another process and apparatus by which transaction cards are printed according to the present invention;

FIG. 5 illustrates another process and apparatus by which transaction cards are printed according to the present invention;

FIG. 6 illustrates a card choice webpage displaying a plurality of card design for selection by a user;

FIG. 7 illustrates an administration interface listing Affinity Groups;

FIG. 8 illustrates a graphic user interface for creating and manipulating a image for a transaction card;

FIG. 9 illustrates a transaction card design comprising different layers;

FIG. 10 illustrates a system of the invention for transferring and printing card design data and user data onto a transaction card;

FIG. 11 illustrates a system of the invention for transferring and printing card design data and user data onto a transaction card;

FIG. 12 illustrates a system of the invention for transferring and printing card design data and user data onto a transaction card;

FIG. 13 illustrates a graphic user interface for creating and manipulating a transaction card design;

FIG. 14 illustrates a graphic user interface for creating and manipulating a transaction card design;

FIG. 15 illustrates a system of the invention for transferring and printing card design data and user data onto a transaction card; and

FIG. 16 illustrates a system of the invention for transferring and printing card design data and user data onto a transaction card.

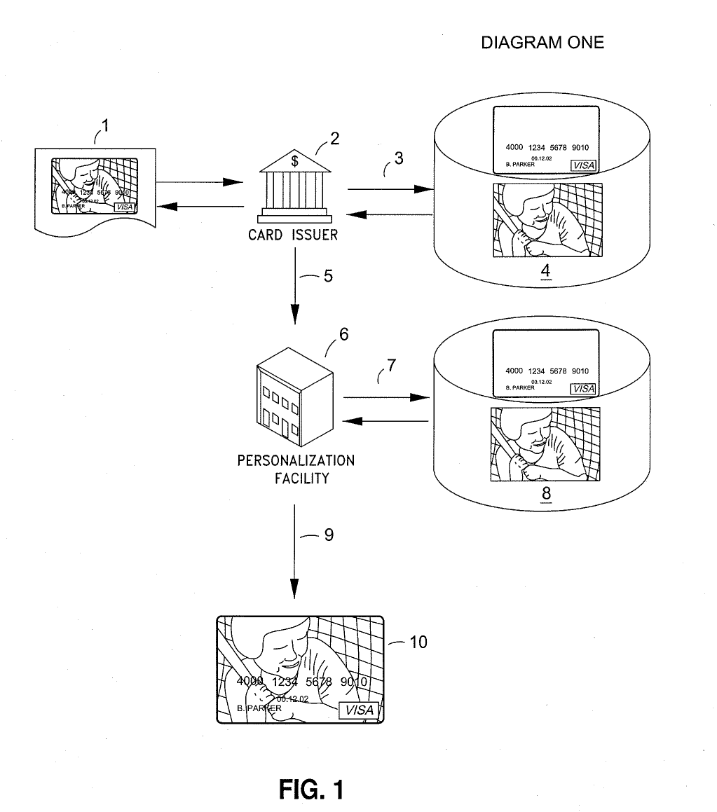

### DETAILED DESCRIPTION

Embodiments of the invention will now be described, by way of example only, with reference to the accompanying drawings.

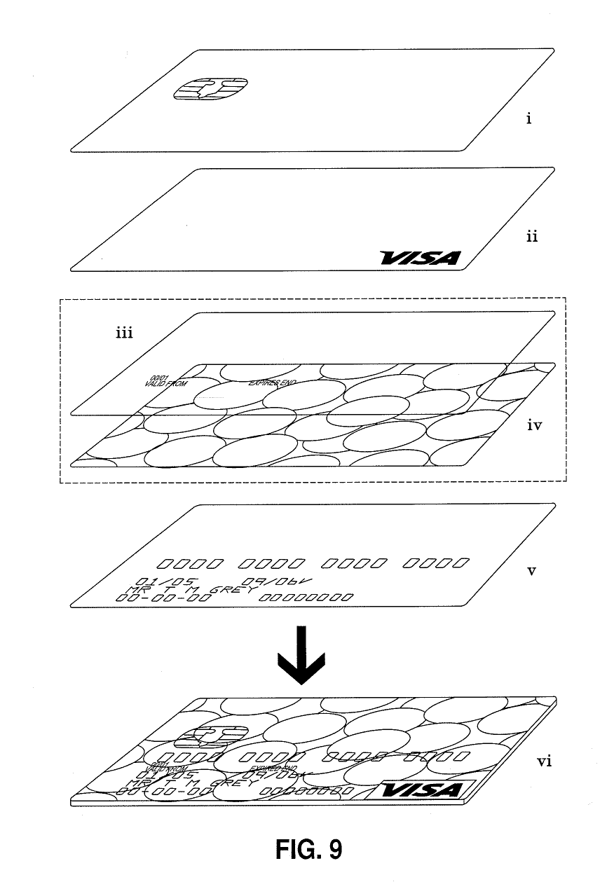

Typically, a transaction card design comprises two components, a product type and a card design. FIG. 9 vi illustrates a transaction card design comprising the product type and the card design. The product type comprises the elements detailed in layers i to iii, and the card design comprises the elements detailed in layers iv and v.

The product type can be created by a Card Issuer. The card designs can be created by a plurality of different users, such as a Card Issuer, a user, and/or an affinity group etc. Different card designs can be applied to the same or different product types.

Layer i defines the size and placement of a transaction card chip. Transaction card chips are commonly known in the art and will not be discussed further in this document. Layer ii defines the appearance, size and placement of an Association identifier, in the example illustrated in FIG. 9, the Association identifier is the logo “Visa”. Layer iii defines the size and placement of product data, such as the numbers “4991”, and the text “valid from” and “expires end”. Layers i to iii combined define the product type.

Layer iv comprises an image which will be applied to the transaction card design. Layer v defines the content of the user data, such as user card number, user account data and user name. Layer iv and v combined define the card design.

The position and size of the user data is considered part of the product type and is defined in layer ii (although not illustrated), such that all transaction cards created using the product type illustrated in layers i to iii are provided with user data at the same position and in the same font and size. In one embodiment dummy user data may be provided in layer v, for example, the dummy user card number may be “0000 0000 0000 0000”.

Although not illustrated in FIG. 9, it is possible for the product type and/or the card design to also define images/text/holograms/magnetic strip etc. that are provided on the back surface of the transaction card. In this embodiment, further layers would define these additional features.

Furthermore, although FIG. 9 illustrates the product type and card design as comprising a plurality of layer, it is not essential that the product type and card design be defined in this manner. For example, the product type/card design may comprise one layer defining all the component parts.

Following creation of the product type a plurality of cards may be printed with the product type alone (and provided with the transaction card chip, if applicable). These printed cards comprising the product type are referred to in this document as “blank cards” and are provided in a blank card storage device. It is then possible for a blank card comprising the product type to be retrieved from the blank card storage device and printed with a card design to create a finished transaction card.

In one embodiment the blank cards are printed and placed in a secure vault at a Card Personalisation Facility.

In some embodiments, the product type comprises holograms and/or sophisticated logos, which can not be printed using digital printers, since the colours of the holograms and/or sophisticated logos are outside the colour spectrum available through CMYK printing and are required at very high dots per inch (DPI) levels, and/or require UV printing. In these circumstances the product type is printed first on a specialised printer and stored in a secure area. However, it is possible to print both the product type and card design onto a true blank card, if a specialised printer is available.

There may be a plurality of different product types defining different blank cards. For examples, credit cards issued by a bank, such as Barclays bank, may use a first black card comprising a first product type and debit cards issued by a bank, such as NatWest, may use a second black card comprising a second product type different to the first product type.

In one example the transaction card is a credit card, which has an annual percentage rate (APR) and possibly additional benefits such as ‘Airmiles’ associated with it. The credit card may also be affiliated with an Association such as Visa, MasterCard or American Express and typically these groups will require their logo to be provided as part of the product type, such that it appears on the front and/or back of the transaction card.

In one embodiment, it is possible for a Card Issuer (for example Barclays Bank or HSBC) to create the product type.

A representation of the product type comprising the fixed elements of the front and/or back of the card can be uploaded to an administration web interface. In one embodiment the product type is approved by at least the Card Issuer, which issues the transaction card. However, in another embodiment the Association (for example Visa or Mastercard) and the Card Issuer approve the product type. The representation of the product type can be uploaded to the administration web interface as an image format that can include transparencies (such as SWF or PNG).

In another embodiment the Association (for example Visa or Mastercard) may create and approve the product type for use by at least one Card Issuer. The Card Issuer can then select and access the pre-approved product types using the administration interface to increase the Card Issuers speed to market with new products. An example of pre-approved product types may be the Visa Classic, Small Business, Corporate, Gold and Platinum card. Following selection of a product type, the Card Issuer can then create the card design for use with the product type, by uploading images (such as layer iv illustrated in FIG. 9) as required.

Approval of the product type is necessary when, for example an Association requires uniform branding across a range of products, or to prevent the Association logo's being used in conjunction with inappropriate images.

In order to create a new product type, the elements of the product type may be uploaded, in one example, in image format. For example, the Associations logo may be uploaded or selected from the plurality of library image elements. In addition elements may be entered manually through text input, for example the product data. The position, size and/or colour etc of each element of the product type can also be defined. The image and/or text can be entered via the administration web interface, complied on a server and returned to the product type creator (administrator) as a layer of the product type or it could be designed as one of many product elements, which are saved at the end of the product type setup process as the product type.

In one embodiment, the product type creator (administrator) includes the Card Issuer's marketing team, the Associations marketing team, and the Card Personalisation Facility's production team.

In one embodiment, following creation of at least one product type, a version of the product type is passed via the web interface to a database for storage.

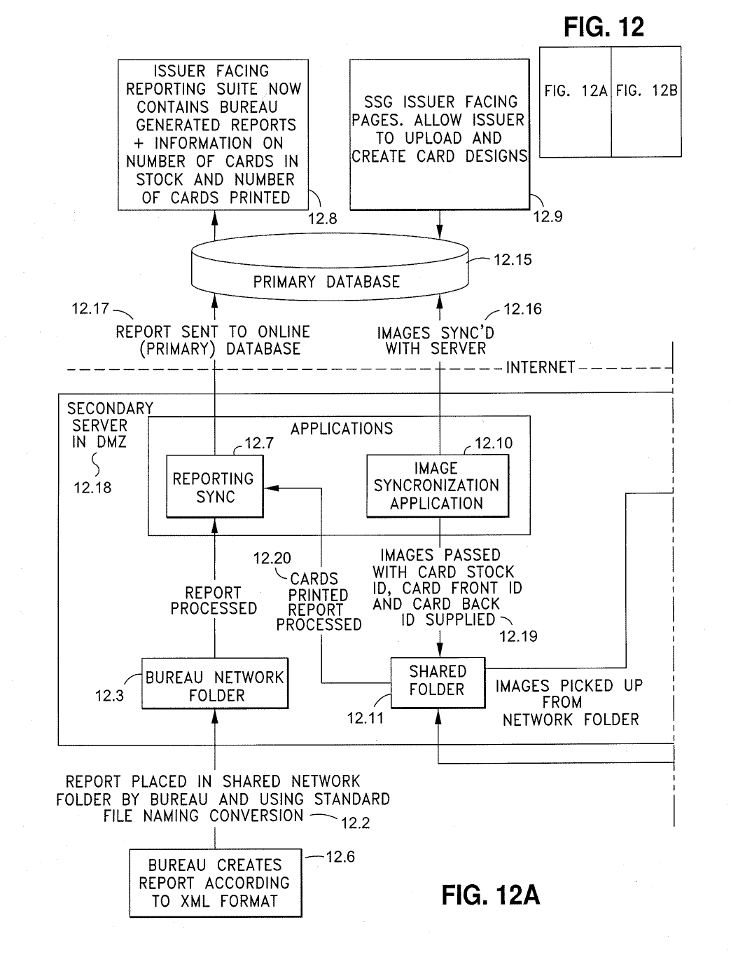

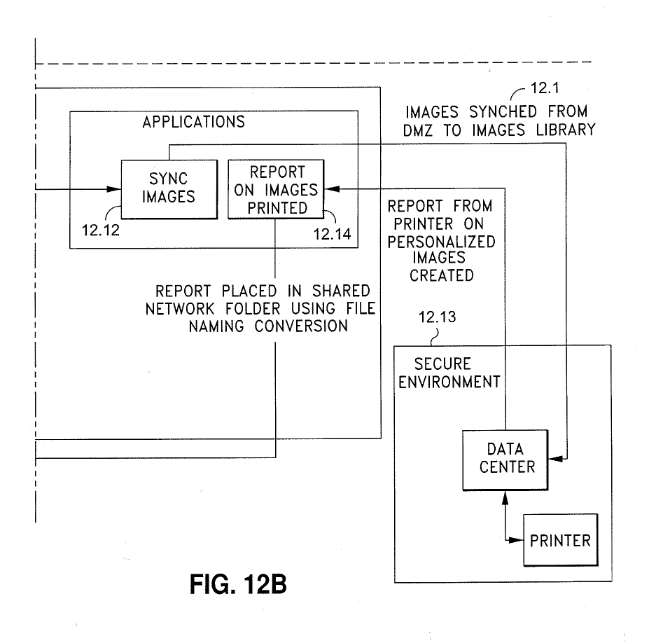

As stated above, following creation of a product type, blank cards can be printed comprising the product type and stored in a secure storage device. In addition, the number of blank cards held in the secure storage device is stored in a database associated with the product type, such that each time one of the blank cards is printed with a card design, this number is decremented. The number of blank cards can only be accessed via a secure web interface, such that it is possible to determine the number of blank cards available in the secure storage device at any one time. Consequently, it is possible to report to the Card Personalisation Facility, the number of blank cards available in the secure storage device, for each product type, to ensure that the number of blank cards of a particular product type does not run low. This arrangement of reporting pre-printed card numbers is illustrated in the system of FIG. 12, explained in detail below.

In one embodiment, the web interface is only accessible via a secure area which requires input of an username and password typically hosted under Secure Socket Layer (HTTPS/SSL). Once access has been granted, the product type creator (administrator) is able to “Create New Product Type”. In one embodiment a name and a description of the product type can be entered. In another embodiment it is possible to have multiple product type ID's (PID) relating to the same new product type. These multiple ID's could be the Card Issuer's PID, Card Personalisation Facility's PID and the PID created by the database when the product type is stored in the database (typically the Primary Key). It is also possible for more than one Card Personalisation Facility to be associated with the database, thus it is possible that there is more than one Card Personalisation Facility PID associated with each product type. The use of multiple PID's allows the Card Issuer to retain their standard Card Issuer's PID set-up (say, “VG” for Visa Gold), which may be used in a number of data fields and different setups and thus is not easily changed, but still allow the printing to be done at a new Card Personalisation Facility by redirecting embossing records to the new Card Personalisation Facility and setting up the new PID in the database.

An embossing record indicates a product type and a card design and includes customer (user) data.

Following creation of at least one product type, a transaction card creator (administrator) can use the web interface to create a transaction card design. As above, the web interface is only accessible via a secure area which requires input of an username and password typically hosted under Secure Socket Layer (HTTPS/SSL). Once access has been granted, the transaction card creator (administrator) is able to “Create New Transaction Card”. The transaction card creator (administrator) is required to select a product type from the pre-defined product types. Once the product type has been selected the transaction card creator (administrator) assigns images (one or more), such as that illustrated in FIG. 9 iv to the selected product type. These images may be simply marketing, i.e. they may have no value other than people can choose the card design that they prefer, or they may have more significance in that the images can be related to particular companies (in the case of corporate cards) or affinity groups.

Either way these images are uploaded or selected, or can be designed using a web-based design tool. In one embodiment, the images can be ‘locked’ so that they can not be manipulated. The transaction card creator (administrator) can also enter default user data.

The created transaction card design comprising the selected product type, images and default user data is then stored in the same (or a different) database and assigned a transaction card ID (TCID). In one embodiment the TCID will comprise the PID.

Typically one product type will be selected for use with several different card designs such that several different transaction card designs are created, each having a unique TCID. Alternatively, the same card design can be selected for use with several different product types if required, again each transaction card design having a unique TCID.

The product type can be stored in the database as a design data packet, the card design can be stored in the database as a design data packet, and the transaction card design can be stored in the database as a design data packet.

Each product type design data packet comprises at least one product type ID (PID), a product type image ID (if the product type comprise an image) and product type manipulation data. As explained above, the PID is a unique identifier associated with the product type. The product type image ID defines an image, such as an Association logo as illustrated in FIG. 9 ii, and is not the same as the card design image. The product type image ID may be a link to or the address of where the product type image is stored, or may be the actual image. Finally, the product type manipulation data comprises instructions, such as for example, as to how to compile the product type, such as where the product type image/chip/hologram etc., and any text should be positioned, text size and font, any colours, coatings, tintings etc. which should be used.

Each card design design data packet comprises at least one card design ID (CID), a card design image ID and card design manipulation data. The CID is a unique identifier associated with the card design. The card design image ID defines an image, as illustrated in FIG. 9 iv, and is not the same as the product type image. The card design image ID may be a link to or the address of where the card design image is stored, or may be the actual image. Finally, the card design manipulation data comprises instructions as to how to compile the card design, such as for example, where the image and any text should be positioned, text size and font, any colours, coatings, tintings etc. which should be used.

Each transaction card design design data packet may, in its simplest form, comprise a product type PID, and card image CID. In another embodiment, the transaction card design design data packet may comprise a transaction card ID (TCID), a product type PID, and card image CID. In another embodiment, the transaction card design design data packet may comprise a transaction card ID (TCID), a product type ID (PID), a card design image ID and card design manipulation data. The transaction card ID is a unique identifier associated with the transaction card design. The product type ID is a unique identifier associated with the product type as described above. The product type ID may be a link to or the address of the product type design data packet, or may comprise the product type design data packet. The card design image ID defines an image, as illustrated in FIG. 9 iv, and is not the same as the product type image. The card design image ID may be a link to or the address of where the card design image is stored, or may be the actual image. Finally, the card design manipulation data comprises instructions, such as for example, how to compile the card design, where the image and any text should be positioned, text content, text size and font, any colours, coatings, tintings etc. which should be used.

In one embodiment the product type image and the card design image can be the same image.

As illustrated in FIG. 9, the various elements of the design data packet are provided on the design interface as a series of layers within a Flash movie. In one embodiment, the layers are held externally as SWF's or PNG's. In another embodiment the layers are a Javascript DHTML (HTML/CSS/Javascript) version. In this way multiple versions of the transaction card design could be created for the various uses listed below.

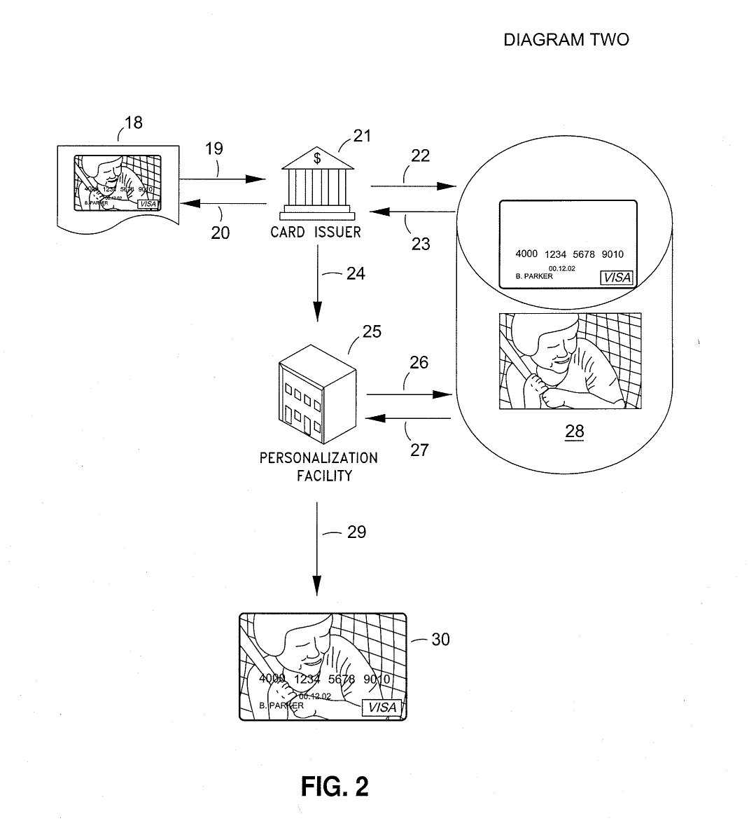

One embodiment for creating a transaction card design according to the invention is illustrated in FIG. 2. As illustrated in FIG. 2, when a Card Issuer 21 wants to launch a new transaction card, a product type, an image(s), and information about how the image(s) should be manipulated (if at all) is collected into a design data packet and assigned a unique transaction card identifier (TCID).

As stated above, the information in a design data packet is determined by an authorized operator (typically a Card Issuer marketing manager) when they desire to launch a new product type or card design. Many components can be brought together including but not limited to the background image, information about spot colours or metallic inks within the design, any overlaying logos and information about these, tipping colours, BIN legends, ‘Good Thru’ dates and coatings. All of this information is contained within the design data packet. Ways of collecting and saving this information could include holding background images as digital files, in JPEG, TIFF, PNG, SWF, BMP, PSD, AI (Adobe Illustrator) or EPS format amongst others. Information on relative position defines how to overlay various elements making up the transaction card design. Information about how to overlay other elements could be held by means of a reference to the location of one corner of an overlaid element (with further information about the use of the file in the header of the file itself) file types which can use this method include vector graphics such as EPS, SWF, PNG and PSD.

An alternative embodiment it is possible to reference the location of one corner of an overlaid element and have a graphic with a fixed “size” as is the case for raster graphics such as bitmaps, GIF, TIFF and JPEG where the number and distribution of pixels can be used to give a scale to an image.

In another embodiment it is possible to pass information about two known points on opposite corners of a element and to size and proportion the element between these points irrespective of the attributes of the element itself.

In another embodiment it is possible to use the proprietary formats of the printing machine or embossing machine.

The information on the exact positioning of brand elements (logos) and legends is defined in the product type by the product type creator. In many cases these positions can be defined with relation to an origin (allowing true flexibility of design).

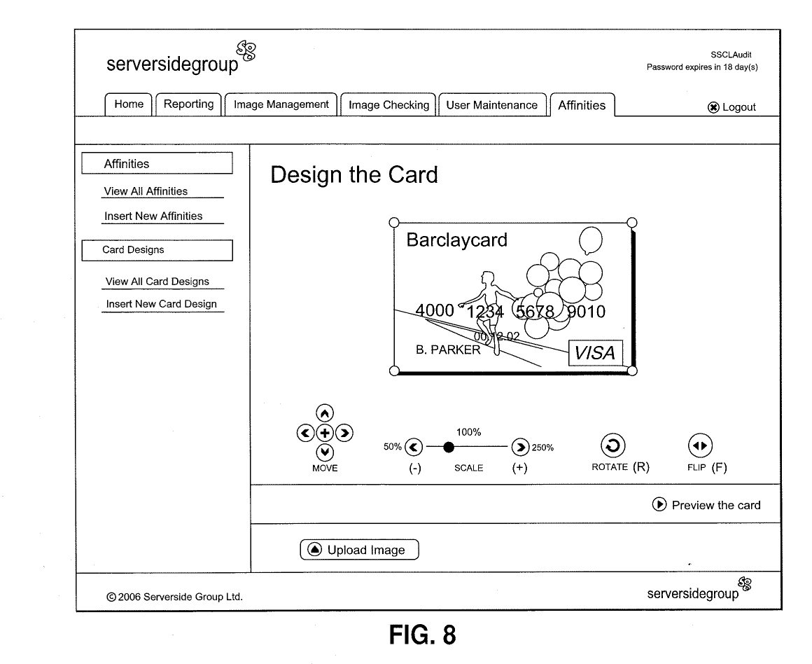

In one embodiment, it is possible for a card design creator to select the position of brand elements and legends from a list of configurations. A list of possible configurations, or even sets thereof, could be pre-loaded such that for example, four options of placement of the various elements and legends are available to the card design creator, the card design creator being able to simply select and review the options from a pull down menu. This information could be graphically displayed to the card design creator using a designer such as that shown in FIG. 8. Typically the fixed elements of the card, such as the brand elements, will be contained within a transparent layer (such as SWF, PNG or GIF). Essentially, this arrangement, although appearing to allow the card design creator to create the product type, in fact enables the card design creator to select one of four pre-defined product types, each product type having the brand elements and legends at pre-defined different positions.

Some of the brand elements and legends will be graphical on the final transaction card, such as the Bin legends, and thus can be treated within this same format throughout the process, i.e. they could theoretically be applied to the transaction card at any stage in order to appear on the final transaction card design. However some are not (many are used as deliberate security features). These include the Embossing and transaction card chip but there are other elements.

Supplemental information about the treatment of non graphical elements can be carried either within the data that composes the element itself (as in the header of a file as described above) or in a separate but related file as meta data. The transfer of this data (and images) to the Card Personalisation Facility could be achieved through a number of means with WebServices, FTP and ‘Connect Direct’ by Sterling Commerce all being viable options (of many).

These approaches can be utilized for graphic elements such as images and text, as well as for special treatments such as tipping or coatings. Information about text elements could include but are not limited to: the text itself, font, size, alphabet, leading, weighting, spacing, colour and position. Information about images may include but are not limited to position scale, orientation, opacity, pigments or inks to be used, spot colours or metallics to be applied. Information about special treatments might include the colour of the tipping to be applied to embossed elements, any laser or hologram treatments and how to apply them, which, if any lacquers or coating to apply and also which, if any, carrier to send the card to for dispatch. All of this information is held in the design data packet.

The type of printer that is being used by the Card Personalisation Facility will have an effect on the contents of the design data packet. In one embodiment the design data packet could contain different data versions for all the different printers with the information delivered in all the different formats required for all supported printers, equally it could contain ‘base’ information that is read differently by the different printer drivers but most efficient would be to only pass the data required by an already selected printer. An example would be that the design data packet for an Artista printer would have an image at 300 dpi whereas the design data packet for an MX6000 printer would have an image at 600 or 800 dpi. Finally it is worth noting that there is no reason in this system for all transaction cards to be produced using digital printers, it is possible for the output to be calibrated for a Heidelberg press for high volume card production (in which case an .ai Adobe Illustrator file would be required).

In the instance that only one version of the design data packet is passed to the Card Personalisation Facility, the creator selects the type of output printer. This could be done in a pre-configured way (i.e. all images are delivered for the Artista), or it could be done via a selection from a pull down menu (or similar) within the administration site, or it could be automated (i.e. low volumes are output to a Desktop printer, mid volumes are output for the MX6000 and high volumes are output for the Heidelberg press).

In one embodiment, the design data packet when decompiled represents information pertinent to the product type and the card design such that a transaction card can be generated from the data. An element of the transaction card design data packet includes a reference to (or a method of referencing) the pre-printed blank card stock comprising the selected product type, the PID. Therefore, the design data packet represents all information pertinent to the transaction card design. In the above embodiment, the design data packet represents a transaction card created or updated by a Card Issuer; an affinity partner of such a Card Issuer; or a customer (user), where the Card Issuer, affinity partner or user selects a pre-defined product type and then creates a card design for application to the selected product type in order to create a transaction card design.

In one embodiment, following creation of the transaction card design by the Card Issuer, affinity partner or user, a representation of the transaction card is passed to additional teams within the Card Issuers (or other third parties thereof), such teams might include the brand team, the legal team, the association team and, for final sign-off, the ‘head of cards’ within the organization.

In one embodiment, the Card Issuer, affinity partner or user can create several transaction card designs without ‘making live’ any of the designs.

Although a single database for storing the design data packets is discussed, it is also possible for the data to be stored within more than one database. However, in this instance there should only be a single version (as in a current version, rather than different formats) of the design data packets. Therefore, it is advantageous to provide one primary database and a plurality of secondary database such that when a design data packet stored in the primary database is updated, the corresponding design data packets stored in the plurality of secondary databases are updated and only a current version of each design data packet exists. In addition, if a design data packet stored in the primary database is deleted, the corresponding design data packets stored in the plurality of secondary databases are deleted. For example, in the Datacard 9000 system, data regarding the location of the embossing elements is kept locally to that machine within its own database. Therefore, this database is the primary database, which controls the secondary databases. This embodiment prevents the production of inaccurate transaction cards, since it is not possible for an administrator to select a product type and/or a card design and/or a transaction card design which is no longer available.

Elements of the design data packet can be created using a graphic user interface such as that shown in FIG. 8 with a number of layers containing the various elements within strict placement guidelines.

During the design process the design data packet is allocated an Identifier (typically the primary key of the appropriate database record). This identifier is used to designate the specific design data packet.

The process for designing a transaction card requires substantial work on the part of the design teams and in one embodiment there are several parties involved which are detailed below:

Editors: The Editors are provided with access to create the transaction card designs and/or the product type. If creating a product type, the Editors can select the position of elements, define text, select tintings etc. If creating a card design the Editors can select an image and are able to manipulate the image and define text. If creating a transaction card design the Editors can select a pre-defined product type and then select an image and are able to manipulate the image and define text. The Editors can save their the transaction card designs and/or the product type as drafts. However, the Editors must obtain approval for their the transaction card designs and/or the product type before the transaction card designs and/or the product type go live, i.e. are saved to the primary database for selection by users.

The Editor has rights to:
1. view the draft version of the transaction card design, card design and/or the product type;
2. edit the text of the transaction card design, card design and/or the product type;
3. add or remove images from the transaction card design, card design and/or the product type;
4. undo all changes to the draft;
5. save the changes;
6. submit the changes for approval;

Approver: The Approver's are provided with access to approve the transaction card design, card design and/or the product type created by the Editors.

The Approver may be:
1. Chief Marketing Officer within the Card Issuer
2. Chief Marketing Officer within the Association e.g. Visa or MasterCard

There can be one or many Approvers but at least one of the Approvers must have approved a change before it goes live.

In one embodiment, once changes have been submitted by an Editor a message will be automatically sent to at least one Approver (typically by email). At this point the Approver is able to log in to the administration interface and see which transaction card design, card design and/or product type is awaiting approval. Is it also possible for the Approver to see the history of changes made to the transaction card design, card design and/or the product type. If the changes are acceptable, then the Approver approves the changes. Alternatively, if the changes are not acceptable, then the Approver can write a note on why the changes have been rejected and a message (again typically by email but other methods could be employed) is sent back to the Editors.

In one embodiment, if the transaction card design, card design and/or the product type is approved, then the message will read: “action=approved; state=in production”. If the transaction card design, card design and/or the product type is declined, then the message will read: “action=declined; state=waiting further edits; notes=Text deemed offensive”. The Editors can then see the draft changes and look at the history, to see what happened. The Editor sees that the text is deemed offensive and can correct it. The Editor will then resubmit the changes for approval or cancel the changes.

Once at least one of, or all the Approvers have agreed that the changes are acceptable an email is generated that is sent to an Actioner.

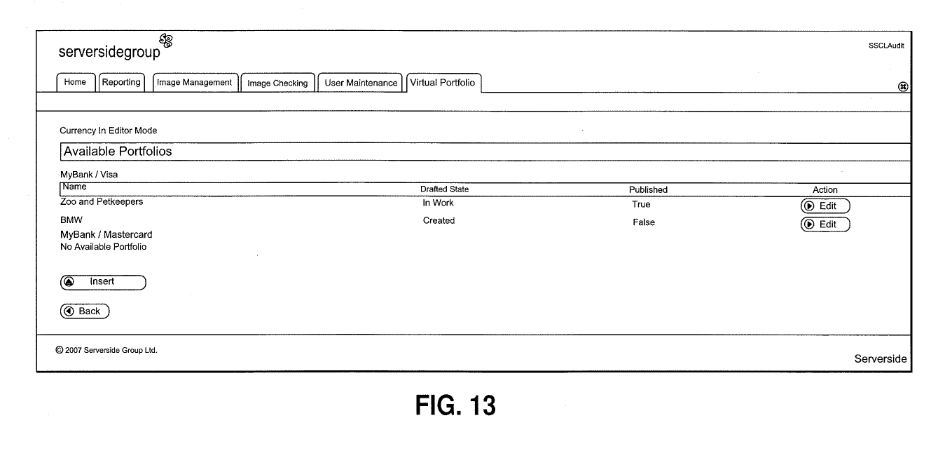

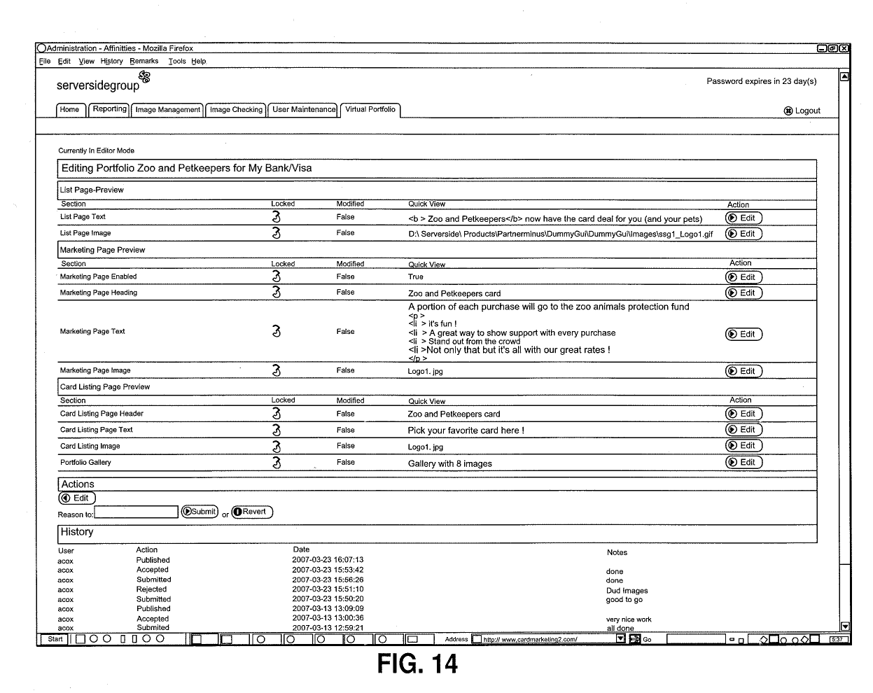

Actioner: The Actioner has rights to ‘Make Live’ the changes to the transaction card design, card design and/or the product type. This will usually be the lead marketer for the transaction card design, card design and/or product type. There can be only one Actioner for each transaction card design, card design and/or product type. At a given time the Actioner can log in to the administration interface and ‘make live’ the changes. FIGS. 13 and 14 illustrates a graphic user interface for creating and manipulating a transaction card design, card design and/or product type.

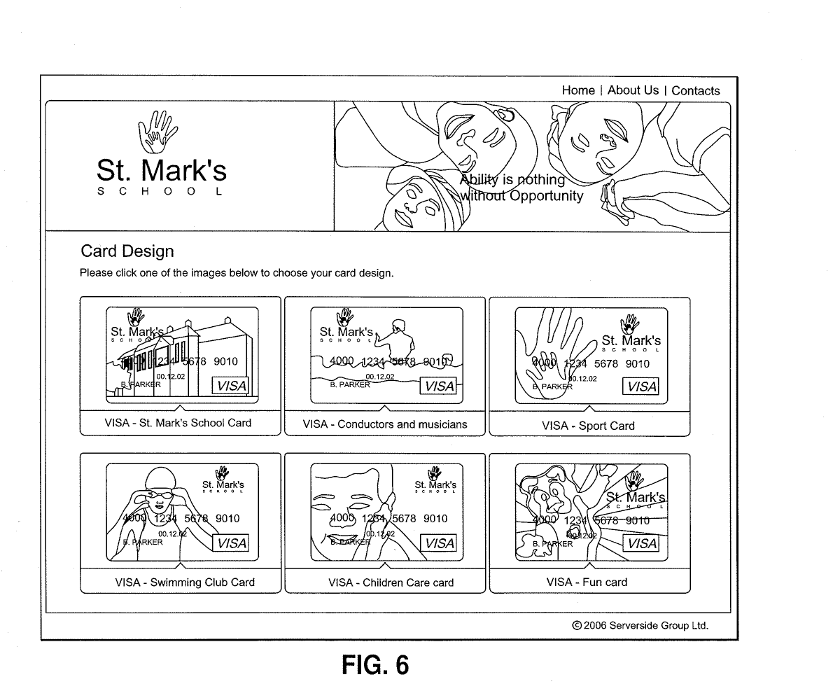

Once a transaction card design has been created, or a plurality of transaction card designs created using the same or different card designs and/or product types have been created, then the administrator has the option of assigning marketing text and/or images to the transaction card design(s). In one embodiment, marketing text is displayed on a website along side a representation of the transaction card design(s), the two elements (with others such as additional images and style sheets) creating a marketing website such as that illustrated in FIG. 6. In one embodiment, the marketing text is stored in the primary database.

In another embodiment, the transaction card design(s) are used in conjunction with a PDF or other document type (for direct mail and other off-line methods). In one embodiment the direct mail document contains pre-signed off content into which a graphical representation of the transaction card design(s) is loaded (a compiled transaction card design). Equally some of the content could be generated through a content management system to change all or some of the marketing text through this interface. An example would be the ability to change the APR that is included within the form, an example of fixed content would be the form field elements of the form (contact details etc). This could be done through exactly the same interface as the web based content is added. In both these cases in the preferred embodiment there could be a disabled or not live option so that the changes could be viewed before going live.

In another embodiment there may be two live versions of the marketing documents, the website documents and the direct mail documents. An ID is associated with the images within those documents (sometime referred to as the champion and challenger) so that the information as to the success of the campaign can be analysed between the transaction card design(s) and the marketing message as a correlation.

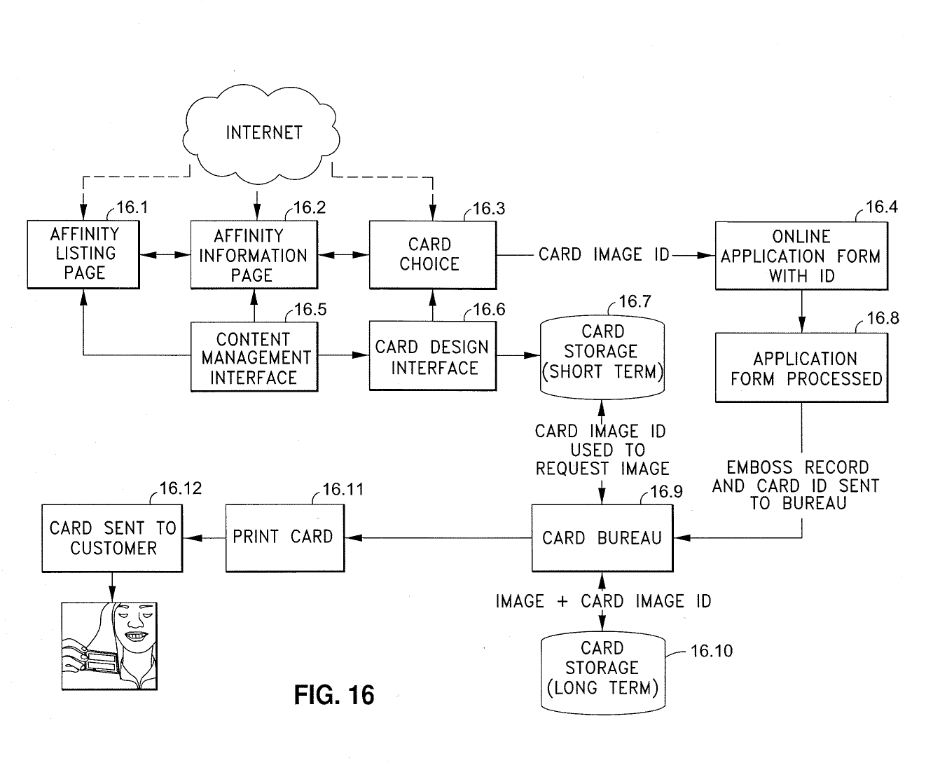

In the website embodiment a potential customer (user) enters a website, reads the marketing messages (see FIG. 16—161, 162,163 and FIG. 6), selects a transaction card design and fills out an application form. An ID (either stored at a user level—i.e. a User ID; or at a card level, i.e. a Card ID) is then retained by the Card Issuer and passed to the Card Personalisation Facility (164 and 168). By using either of these ID's, the correct transaction card design can be related to the user (169 and 167).

The process for signing-off marketing text, images and affinity (and co-brand and corporate card) groups can be achieved through the same process as described above for the transaction card design(s).

FIG. 6 illustrates a web page which is used for online marketing. The web page comprises six transaction card designs. The representations take the form of a database lookup, in some instances directly from the marketing hypertext page as an http or https reference. In FIG. 6, a fictional school “St Marks” (an affinity group) has signed up with a Card Issuer and produced six affinity group transaction card designs. The transaction card designs which are illustrated on the web page to the user are the same transaction card designs as printed by the printer at the Card Personalisation Facility. However, the format of the design data packet which is used to generate the illustration of the transaction card designs on the webpage may be a different format to that used by the card printer, for example the card printer may require a greater dpi.

In one embodiment described with reference to FIG. 16, typically three marketing web pages (161, 162 & 163) can be created for the user. One is a listing page (161) which will have a list of all the available Affinity programmes, the second will have further information about a selected Affinity programme (162) and the third is the transaction card design selection page (163), the link from this page (163) would typically go directly to the Card Application page (164). One final interface that can be generated is an image with a link embedded (in a format such as <a href . . . ><img src . . . ></a>—or simply a link <a href . . . >click here to get your New York Opera Card</a>) which can be copied by the affinity itself and pasted on to their website as a promotional tool. This link will include the TCID and may be directly passed to the application form 164. In one embodiment, this code can be used on a companies Intranet if the affinity group is a company. In another embodiment this code can be auto-generated within the management interface and supplied to the affinity group either automatically or manually.

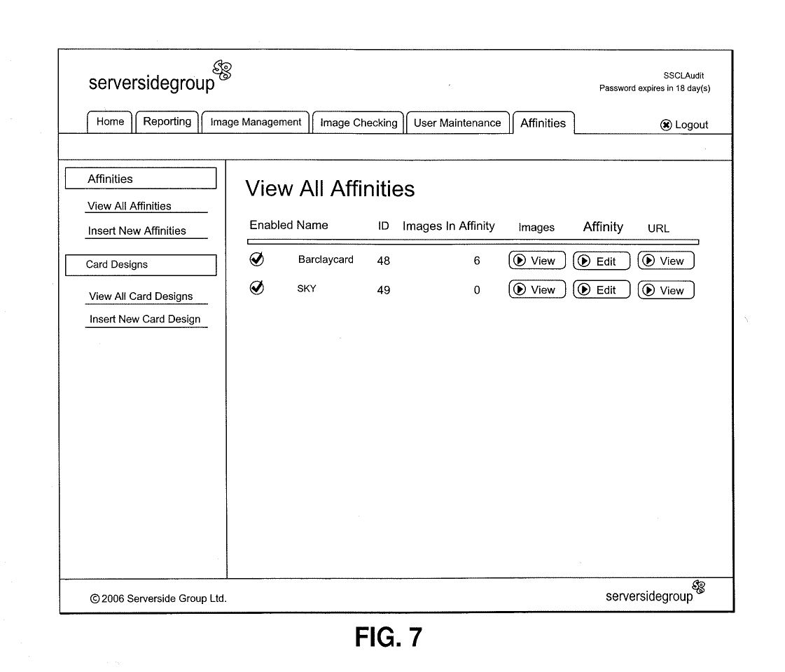

The affinity groups are listed on an administration interface (as illustrated in FIG. 7 and FIG. 16—165 and 166). A marketer at the Card Issuer, or a marketer of the affinity group, for example, can create one or more transaction card designs which are assigned to the affinity group using a design interface, such as that illustrated in FIG. 8. The created transaction card designs are then presented to the user as a webpage such as that illustrated in FIG. 6. Interested groups, such as parents at the school or alumni, can then choose a transaction card design by clicking on the transaction card design they desire.

Different versions of the design data packets and the card images are held in the primary database as stated above. The different version are used in different ways, which include (but are not limited to):
1. The transaction card designs that are sent for printing comprise:
   i. a link to or a version of the card image having areas ‘knocked out’ to allow the positioning of the brand elements which are provided on the blank card stock comprising the product type, or a link to or a version of the card image having the brand elements (and additional marks) laid on the image before sending to the Card Personalisation Facility; and
   ii. manipulation data defining how the Card Personalisation Facility is to treat the image, and details of default card numbers or default card holder name, which are to be added by the printer software just before printing.
2. The transaction card designs that are presented to a web user (as shown in FIG. 6) comprise:
   i. images manipulated in accordance with the manipulation data and provided with the default card numbers and/or default card holder name information overlaid on the image and presented as, for example, a JPEG, GIF, BMP or PNG to the user; and
   ii. the product type which is overlaid as an SWF file, a PNG file or a similar transparent layer. The image and product type are kept separate and can be manipulated separately in the browser—thus two different association branding can be delivered to the user and manipulated with DHTML (or Macromedia Flash) or similar to enhance the user experience.
3. The transaction card designs that are presented to marketers and advertisers have a very high quality original image, since standard advertising print is at 800 dots per inch. These images can be delivered to the advertisers using an automated function, such as email, that is automatically generated when a new card design is added or when a change is made to the design data packet.
4. In one embodiment, each user can create the card design for application to any of the pre-defined product types. In this embodiment the user creates their card design using a ‘designer’ such as that described in WO 04/074961 and incorporated herein by reference. The product type is used to format the fixed elements of the card. In this embodiment the image is checked to ensure that it is acceptable to the Card Issuer and the card Association. The user may be sent a small but fully branded version of their transaction card design as part of the acceptance or rejection process. The acceptance version will be formatted using the user card design design data packet, which indicates the product type. The rejection email may also include a small but fully branded version of the transaction card design. However, the transaction card design may be branded differently—such as to include “censored” information overlaid on the ‘offensive’ image.
5. In the embodiment where the customer has internet banking or where the bank wants to use email or MMS or other image rich communication method to contact the client then the transaction card design can be used (or a portion of the transaction card design) as an anti-‘phishing’ device. Here the user may be presented with the transaction card design or version (format) thereof with a related question, or the transaction card design is supplied simply to give the user comfort that the bank interface is genuine or the transaction card design may be one of a series of transaction card designs with the user being required to select one.
6. The transaction card design, in yet another version (format), may be used on statements or print based communications with the user.
7. When a new transaction card design is created or an existing transaction card design is altered, the corresponding design data packet is communicated to the Association or the Card Issuer head of marketing for ‘signoff’.
8. A further image of the transaction card design may be used within the card collateral that is sent to the user when the card is delivered. A version of the transaction card design may be used on the outside of the envelop for example. Again this may be a different version (format) of the transaction card with different embossing overlays such as the users actual name on the transaction card rather than a generic ‘Mr. J. Smith’ embossing overlay.

The transaction card ID (TCID) can be used in a number of fashions by the Card Issuer. Two embodiments (not necessarily exclusive) are disclosed here but there are others:

1. As illustrated in FIG. 16, the design data packets can be used (as disclosed above) to create marketing images. These marketing images are displayed to a potential cardholder (user) in the form of a card choice webpage (such as illustrated in FIG. 6). Each of the transaction card designs displayed will be labelled with an unique ID (TCID). In one embodiment, the page is created using HTML and a serverside scripting language such as ASP.Net, PHP or Coldfusion. The CID can be contained within the ‘Link’ of the transaction card design image. The code for such as link might be <a href=cardissuer/cardsignup.aspx?CID=12> <img scr=CARDDESIGN12.jpg> </a>. If the user clicks on one of the transaction card designs they will be forwarded to an application page 16.4 with the TCID information included (TCID=12). The Card Issuer can include the TCID within the embossing record and subsequently it can be used to pull the correct design data packet at the point of personalisation (i.e. embossing and printing 16.11). Included within this link to the Card Issuer can also be an Affinity ID (see the example of St. Mark's in FIG. 6). This Affinity ID will denote the Affinity that has set up this card program (i.e. the selection of transaction card design images that the user can select from and marketing text). By passing the Affinity ID it is possible for the Card Issuer to correctly disperse the financial aspects of the affinity program. The Affinity ID in this scenario would be passed with a link like: <a href=cardissuer/cardsignup.aspx?CID=12&AffinityID=232>.

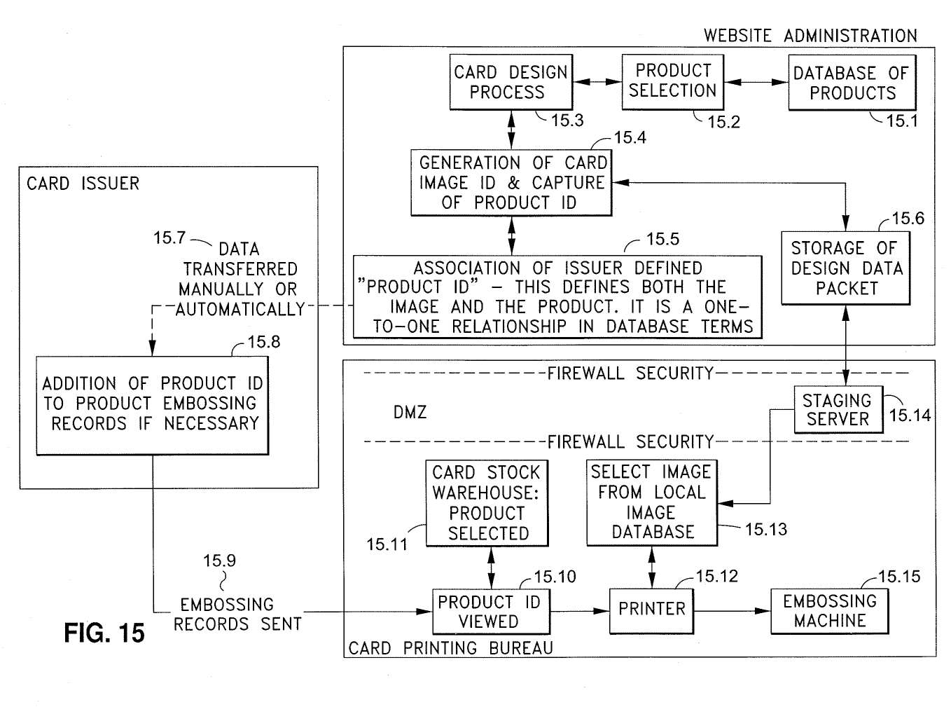

2. In this scenario the Card Issuer is shown the TCID at the point that the design data packet has been completed (see FIG. 15—154 and 155). The Card Issuer can now simply copy the TCID. The TCID can then be added to the embossing record for an entire product type (i.e. this is not for an individual card application but for a product range 157 and 158). What this enables the Card Issuer to do is to quickly and easily move from an analogue printing solution to a digital one, with all the attendant benefits in terms of speed and ease of production. This process is unlikely to be complex for the Card Issuers as the product type will already be communicated to the Card Personalisation Facility in the standard method (159). Typically the TCID will be either included in each embossing record within a batch or included within the Batch name and be representative of all the records within that batch. To make the likely changes to the Card Issuers systems less onerous (though they should be relatively simple anyway) it will be offered as an option to the Card Issuer to swap the TCID for a new ID that will fit within the data types that are presently used within the existing system (for example the TCID might be a 3 digit number but could be changed for a 5 Character ID).

FIG. 2 illustrates a process of the invention. Methods by which the image is sent to the primary database 28 can include the internet or other networks or other portable digital media such as a disk or memory device. The design data packet and TCID are stored in the primary database 28 and a multiplicity of version of compiled card designs that represent the design data packet can be created of varying file types and sizes. In order to create these compiled card designs, differing elements of the design data packet are laid up digitally based on the information therein and a composite digital representation of the card, the compiled card design is created. The size and format of this composite image will vary depending on the media and purpose it is intended to serve however all representations will look similar even if they are of differing size.

When the card issuer 21 wishes to use the transaction card design for marketing or advertising 18 either the design data packet or a compiled card design is requested 19 and 22, and retrieved 20 and 23 directly from the database 28 and can thereafter be used in marketing document(s) 18. In this context a compiled card design may be regarded as a card design generated based on the information in the design data packet. As will be explained in more detail hereinafter, there may be a variety of compiled card designs with different characteristics or properties suited for different intended purposes.

The design data packet therefore may be in an XML file or other format in two sections with the included image files referenced as a third section. These elements may be transferred for ease in a package format such as ZIP or RAR. One section will deal with the various settings within the design data packet. This may include detail such as (BIN=[4354], BIN treatment=[INNER GLOW]) or <BIN OVERLAY=[bin121.png]>. In another section the various different usages, listed above, will have a number of attributes that are switched on or off thereby determining the treatment to be delivered to the image before delivery or the data that should travel with the image on delivery.

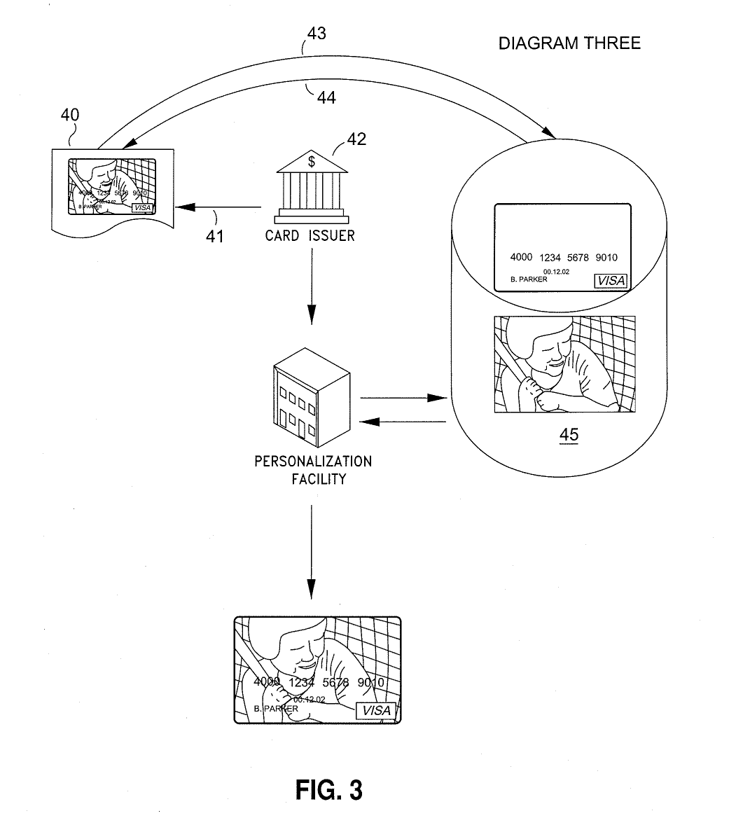

This scenario is more fully explained in FIG. 3. In this case the user requests a web page or other digital document 40 from the issuer 42, this document having a reference to a transaction card design in the database 45. In this example the reference initiates a request to the database directly 43 and either the associated design data packet or a compiled card design is returned directly 44. In another embodiment, the data can be called from the database 45 via the issuers servers 42 as illustrated in FIG. 2 (19, 20, 22 and 23).

In the instance of printed materials the image can be looked up directly from the database when materials are designed and printed.

In one embodiment the transaction card design may need altering or updating. In this embodiments it is possible to overwrite the design data packet associated with a TCID in the primary database with a new version of the design data packet and subsequently all compiled card designs displayed through digital marketing for the aforementioned TCID will be updated, as will all marketing created utilizing the TCID thereafter.

Referring to the embodiment illustrated in FIG. 2, when a consumer or other card applicant or cardholder selects a transaction card design displayed as a complied card design at 18, the choice can be communicated 24 to the personalization facility 25 in a variety of ways which specifically include but are not limited to digital networks and physical (including digital) media. The CID of the selected transaction card design and cardholder identifiers (typically including name, address and relevant financial information) are preferably sent together.

On receiving the information, the personalization facility requests 26 the relevant design data packet from the database 28 and the corresponding image(s) data/template(s) data/instruction data, based on the design data packet are returned 27. The methods for looking and retrieving the records specifically include but are not limited to digital networks (most typically using web services) and physical (including digital) media.

The personalization facility 25 now prints the correct transaction card design 30 for the cardholder and delivers it 29 to the cardholder.

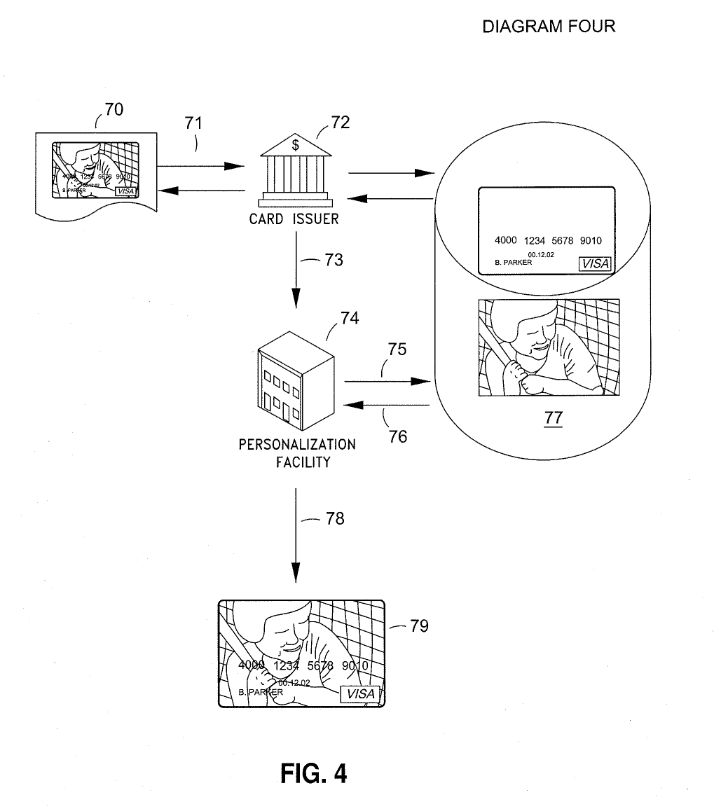

Referring to the embodiment illustrated in FIG. 4 an existing user or new user (applicant) selects a transaction card design displayed as a complied card design 70 (in one embodiment) from a plurality of transaction card designs. The complied card designs are displayed from the database 77. When the users selects one of the transaction card designs, the TCID indicating the selection is communicated 71 to the Card Issuer 72 but not to the database 77.

The information about the transaction card design request is then communicated 73 to the Card Personalisation Facility 74. The information could include all relevant user financial and personal information and the TCID. This information can be communicated in a multiplicity of ways and in this application is referred to as an embossing record.

On receipt of the embossing record, the Card Personalisation Facility 74 requests 75 the design data packet which is associated with the TCID from the database 77. The database 77 returns 76 the associated design data packet to the Card Personalization Facility 74.

The Card Personalization Facility 74 then prints the correct card design 79 onto the correct blank card stock for the user and delivers it 78 to the user.

An advantage of this embodiment is that it is not necessary to communicate a user ID to the database.

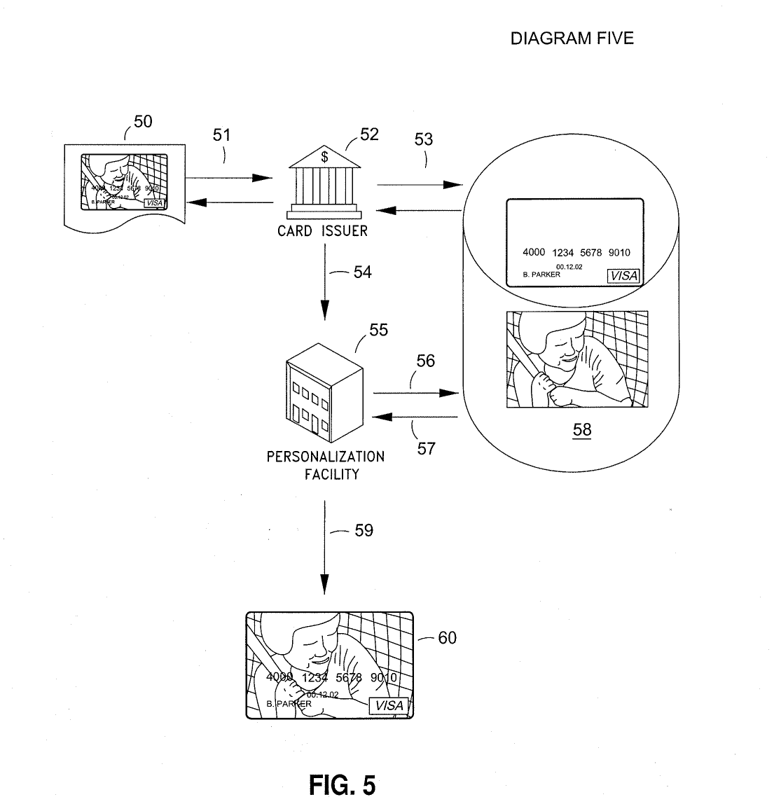

Referring to the embodiment illustrated in FIG. 5 an existing user or new user (applicant) selects a transaction card design displayed as a complied card design 50 (in one embodiment) from a plurality of transaction card designs. The TCID associated with the users selection is communicated 51 to the Card Issuer 52. The Card Issuer 52 associates a unique user identifier UID with the user and communicates 53 the CID and the UID to the database 58. For example, a user associated with the UID 25 selects the transaction card design associated with the CID Z. Consequently, the information passed to the database 58 would be as follows:

| | |
|---|---|
| UID | 25 |
| CID | Z |

This information is then stored in the database 58. Typically there will be many UID per CID (in a relational database).

Separately, the CID and UID is also communicated 54 from the Card Issuer 52 to the Card Personalization Facility 55 together with all relevant user financial and personal information associated with the UID. This information can be communicated in a multiplicity of ways and is referred to in this application as an embossing record.

On receipt of the embossing record the Personalization Facility 55 requests the design data packet which is associated with the UID 25, which in turn is associated with a CID Z in the database 58, from the database 58. The database 58 retrieves the information about UID 25, determines the corresponding CID is Z, and returns 57 the design data packet associated with the CID Z to the Personalization Facility 55.

The Personalization Facility 55 now prints the correct card design and user data onto the correct blank card stock 60 and delivers 59 a transaction card comprising the selected transaction card design to the user.

An advantage of this embodiment is that the communication of a “UID” allows for greater data mining (for marketing response analysis for example) and customisation of a transaction card design since the individual user is known throughout the cycle and it is not necessary to transfer large amounts of information for each card every time it is requested.

In another embodiment, still referring to FIG. 5, an existing user or new user (applicant) selects a transaction card design 50 displayed as a complied card design (in one embodiment) from a plurality of transaction card designs. The selection is communicated 51 to the Card Issuer 52 not as a TCID but as the design data packet. The card Issuer 52 associates a unique user identifier UID with the user and communicates 53 the design data packet and the UID to the database 58. In this embodiment, the CID and UID have now become interoperable and the same: either identifier could be utilized in this scenario. The term UID will be used for simplicity to mean either or both.

The UID and associated design data packet are stored in the database 58.

Separately, the UID together with relevant user financial and personal information is communicated 54 to the Card Personalization Facility 55. This information can be communicated in a multiplicity of ways and is typically referred to as an embossing record.

Consequently an embossing record indicates the selected transaction card design, whether by TCID or UID, in some embodiment also indicates the user and comprises relevant user information.

On receipt of the embossing record the Personalization Facility 55 requests 56 the design data packet which is associated with the UID from the database 58, and the database 58 returns 57 the design data packet to the Card Personalization Facility 55.

The Personalization Facility 55 now prints the correct transaction card design and user data onto the correct blank card stock 60 and delivers a transaction card comprising the selected transaction card design 59 to the user.

The advantage of this embodiment is that whilst much data is transferred, small adjustments and personalization can be added to the card for each individual.

It should be noted that the above embodiments are not mutually exclusive, there are a multitude of hybrids where some information is sent along with the UID and the bulk of the design data packet is sent associated with a TCID and the two are compiled to create a unique card without the necessity of transferring all information every time.

Embodiments of the invention will utilize a cache system at the Card Personalization Facility, as a useful method of reducing unnecessary file transfers.

One of the advantages of the system of the invention is that it has a single database to manage the various transaction card designs. However, in another embodiment, a replication system between the primary database and a second database exists. In one embodiment the primary database is held online and allows access to the servers, to the internet and the card marketers and the card users. The second database is held local to the print device so that images for application to the transaction card design can be pulled at great speed. In this arrangement, the primary database will be the ‘master’ and is replicated by the local server, since most key data will be entered online. However, the second local server could be the master if required.

FIG. 15 illustrates an embodiment where a Card Issuer creates a transaction card design by selecting a pre-defined product type and then creates the card design for application to the selected product type.

As illustrated in FIG. 15, a plurality of pre-defined product types are stored in a database 151. This database 151 may include data such as the Product Name associated with the product type (if required), the design data packet associated with the product type, the product ID (PID) associated with the product type (which may remain internal to the local system), and geographic region data, since different products types may only be applicable in different regions (for example, Visa has six geographic regions, each with different product types for their platinum and gold cards).

An administrator (user) at the Card Issuer (such as a bank) can select one (or more) of these predefined products types using the interface 152. The predefined product types are representative of pre-existing blank card stock stored at the printing facility.

The administrator begins the card design process at 153 with reference to the product type previously selected. FIG. 8 illustrates one embodiment of a card design interface. Once the card design process is finished at 154, the card design and an associated card design ID (CID) can be generated (although they can be generated later).

At this point 155 the administrator is offered the option to apply a single transaction card ID (TCID) to the transaction card design comprising the selected product type and the created card design in combination. The TCID selected can be the same as the one already in use between the Card Issuer and the Card Personalisation Facility, as illustrated at 157, 158 and 159. The transaction card design is then available for selection by a customer (user). In its simplest form the TCID can merely reference the selected product type ID (PID) and the card design ID (CID).

A customer (user) can then select one of the pre-defined transaction card designs. The selected transaction card design is associated with the user and an user embossing record detailing user data and transaction card design data (TCID) is sent to the Card Personalisation Facility (printer).

Once the embossing record arrives at the facility 1510, the PID of the TCID is used to select the correct blank card stock (product type) from the warehouse or vault 1511.

The blank card is then printed 1512, 1515 with the correct card design and embossed with the user data. At this point the image indicated by the CID is pulled from the local image store 1513 which selects the image from the staging server with the DMZ 1514. Consequently, it is possible for a standard printer to print a plurality of different transaction card designs.

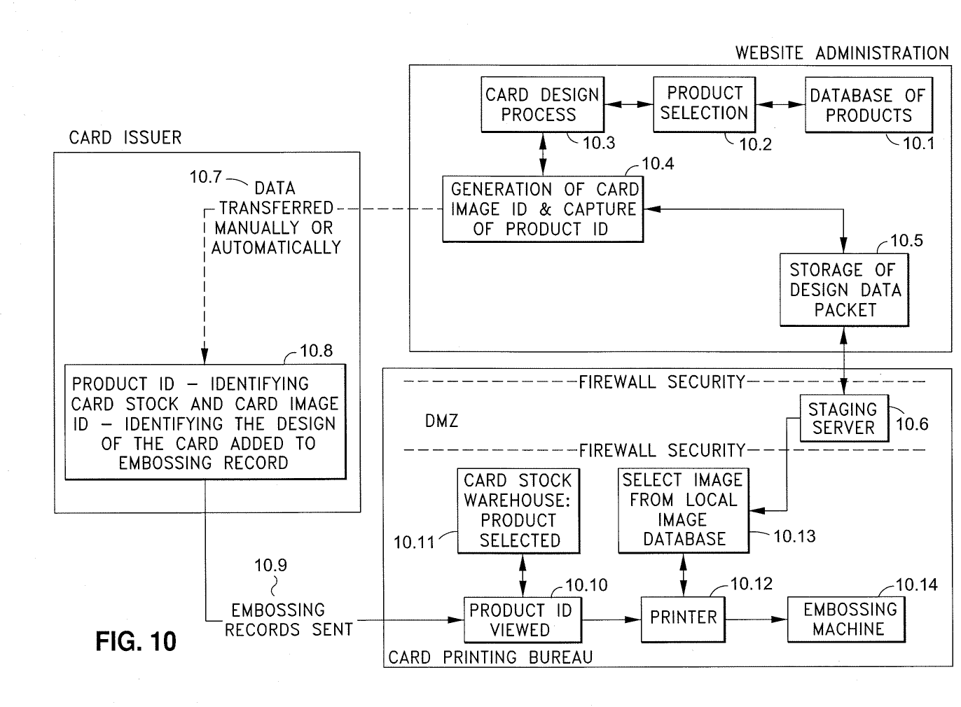

Typically there will be a one to many relationship between the product type (say a Visa Classic card) and the card design that is placed upon the card (which could be an affinity image). Therefore, in one embodiment both the PID and the CID is passed to the personalisation facility in the embossing record as illustrated in FIG. 10, or in another embodiment illustrated in FIG. 15 the PID is associated with the CID but not passed with the CID in the embossing record.

The process illustrated in FIG. 10 starts at the Transaction Card Design Administration Site. The Administrator (user) for the Card Issuer, design agency or Card Personalisation Facility selects a product type 102 from the at least one pre-defined product types and then creates the card design 103 using images which can be uploaded or by choosing from a gallery of pre-loaded images. The system produces two IDs the card design ID (CID) and the product type ID (PID) (however, in another embodiment, the ID's may not be required since human communication could be used, for example). The administrator takes the ID's 104 and 107 and adds them to the banking system where they can be processed as part of the embossing record 108 and 109. In the meantime the card design (in the form of a design data packet associated with a CID and/or the card design image) can be passed to the Card Personalisation Facility (printing facility) and (in one embodiment) placed in a DMZ (De-Militarized Zone or secure area), such as a local database typically by Webservice. The Card Facility will then be responsible for the movement of that file 106 to 1013 into the main body of the Card Personalisation Facility itself.

At 1010 the embossing records are passed to the Card Personalisation Facility. Although the steps of this process have been described in an order, the steps do not have to be completed in that order. It is for example possible for the image of the card design to be called from the Card Design site on request by CID from the Card Facility. At 1011 the correct blank card stock is gathered from a secure vault based on the PID. The blank card stock is placed in the printer 1012 and the correct image (and potentially all the other elements of the card design) called by the CID 1013. The card is then printed.

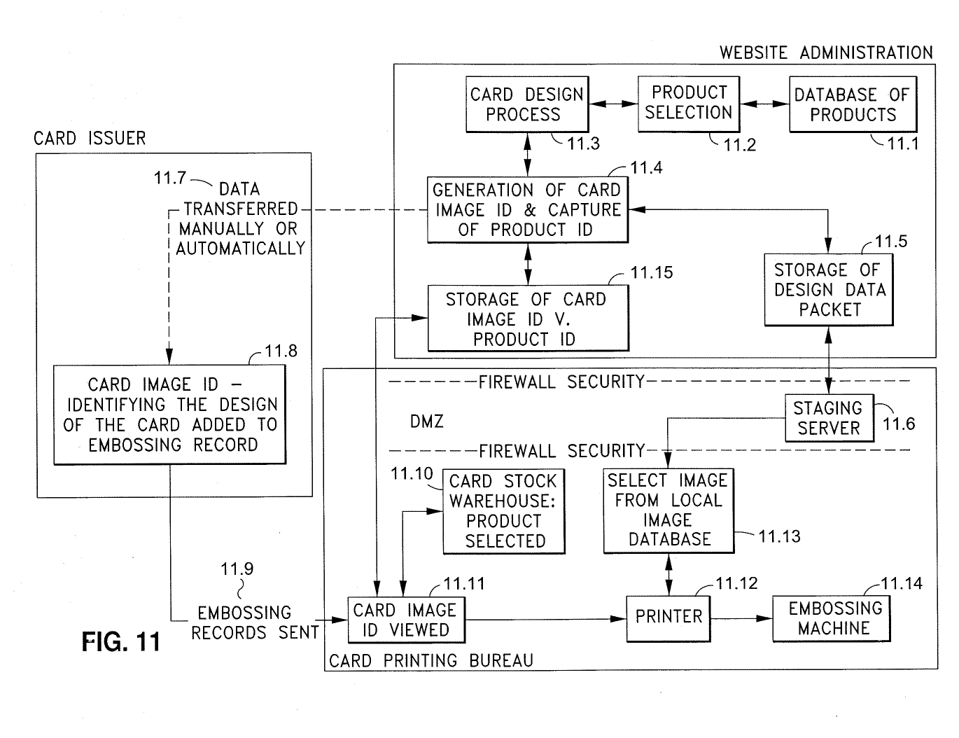

Another option is to pass only the CID via the Card Issuer knowing that through a call to a relational database the correct product type can be requested. FIG. 11 illustrates this embodiment. Another method is for either the Card Issuer or the Card Design Administration Site to pass the information about the relationship between themselves and the Card Personalisation Facility such that the facility has a local (digital or analogue) list of the product type ID's and their related Card design ID's. Typically this process would take place once the embossing records had been passed to the Card Personalisation Facility and a look up would take place against the database (or the secondary/slave version) to determine the blank card stock which is required. This means that the facility can look up the PID based on the CID as illustrated in FIG. 11. Typically this relationship would be held in a database table on the primary database (and backed up to secondary databases within the Card Personalisation Facility as discussed above). This process requires a Many to One relationship i.e. there is only one PID for each CID, but the choice of process depends largely on the specific data transfer requirements of the Card Personalisation Facility and Card Issuer.

| ID type | ID | Description |
|---|---|---|
| PID | VC | Visa Classic |
| CID | Z | Cougar |

In another embodiment, it is possible to de-couple the ID's that the Card Issuer uses to identify the product type and the card design that is applied onto the front (and/or back) of the transaction card. By de-coupling these ID's the Card Issuer can continue to use the same TCID even if the card design is changed. An example of this would be a Card Issuer having a transaction card called, for example Visa Classic and it is associated with the TCID ‘VC’. This transaction card has the Card Issuers branding on it. At a later date the Card Issuer wishes to update the branding but by de-coupling the card design from the TCID used to describe it, the card design can be changed without having to change the TCID. This is very useful as the TCID may well be used throughout the Card Issuers system for a number of purposes, thus changing it (simply for a branding change) could be difficult and expensive. As the TCID need not be changed the card design can be updated very easily with no additional repercussions.

In one embodiment the Card Personalisation Facilities are held under very high security and thus the relationship between the printer and the online database will typically be one that has an intervening DMZ (or secure area), as illustrated in FIGS. 10, 11 and 12, with files transferred through the DMZ in a controlled fashion. It is therefore not usually possible to make real-time look ups between the online database and the printer. However, a secondary database can usually be used to allow this as discussed above.

Another embodiment is illustrated in FIG. 12. The process is initiated at point 129 where a Card Issuer selects an image by uploading an image, or selecting an image from a pre-defined gallery of images, or makes a change to the marketing text for an existing transaction card design, or adds, delete or changes any of the settings defined in a product type design data packet.

When a change is made a synchronizing process takes place 1216 so that the secondary database 1210 is kept up to date with the new data. Included within the transaction card design data packet is the transaction card ID, (in one embodiment a CID) the image (whether the actual image or a link or address of where the image is held) which is to be applied to the card front and associated manipulation data, the product type ID (the ID used to define the product type) and, if applicable, the image (whether the actual image or a link or address of where the image is held) which is to be applied to the card back and associated manipulation data. All of this data is placed within a shared folder 1211 so that the printer system (in one embodiment the MX6000 system by Datacard) can then access these images 121 to print the card design on the blank card indicated by the product type ID.

When the cards have been printed within the Secure Environment 1213 a report (on how many cards have been printed, on what days, of what image, of what product type etc.) is sent by the printer hardware to the secondary server 1218 and the report data placed in the shared folder 1211. This data is then picked up by the system and passed 1220 to the synchronizing application 127. The report would typically at this stage be of pure data (in say an XML format on a daily or hourly basis), this data could then be presented to the administrator on the web interface in either an on demand, searchable or highly definable user generated report or via routinely created (say, monthly) reports.

This data is then passed back 1217 to the primary database 1215 and displayed on demand to the Card Issuer 128.

If the Card Personalisation Facility wishes to report information about the process to the Card Issuer then by creating the data 126 and passing it to the application via a network folder 123 the reporting can be relayed to the Card Issuer via the same reporting interface 128.

In one embodiment, it is possible to provide content (i.e. images) to the database. By providing pre-approved images in a database, the pre-approved images can be selected by a Card Issuer, assigned to a pre-approved product type and a transaction card design created and made available to users potentially in a few minutes

One method for obtaining images is via purchasing them and the delivery of this content on a royalty or one-off purchase basis from content providers (such as Getty Images) or via industry bodies (such as Visa or MasterCard). Typically these images would be tagged for usage (premium content on premium cards), with a specified number of editions (cards that can be produced) or by there content (such as the theme (happy, sad), subject (animals, landscape) or a free text area for very precise descriptions “jumping spaniel”)).

In another embodiment an online competition can be provided where people submit card designs which can either be voted for online or be selected by a panel of judges. In an advanced version it would be possible to use the image tagging described above but also allow designers to name their price, either for all out purchase of the image for use on a card (potentially within a particular geographic region or product type) or on a per use/card produced basis.

The transaction cards described throughout this description may be financial transaction cards such as payment cards, credit cards, debit cards, and cash cards etc. Alternatively, the transaction cards may be security cards, driving licenses, loyalty cards, ID cards, gift cards, telephone cards or the like. This list is provided for illustrative purposes only.

Furthermore, a compliable card design may be adapted for use in one or more of:

1. card production;

2. presentation to a web interface;

3. presentation to a marketing or advertising suite interface;

4. presentation to a personal card designer interface;

5. presentation to a content screening interface;

6. presentation to an internet banking interface; and

7. presentation to a printer for hard copy correspondence.

The embodiments of the invention allow for integration and unification of the databases utilized in the production of transaction cards and the combination with image manipulation facility which enables the reconfiguration of the system. Previously the database at the Personalization Facility was a vault of physical plastic cards so this integration was not possible.

However, with the advent of digitally produced cards, this inventory can become digital and virtual, and prior to the invention it has been separate from the database utilized by the card issuer leading to inefficiencies and subsequent costs.

Embodiments of invention provide many and different advantages, for example:

(I) Removal of duplicate records prevents wrong card designs being printed.

(II) Ability to rapidly and cost effectively launch, manage and remove card designs directly from the Card Issuer drives marketing efficiency and greater choice.

(III) Ability to track a card design from marketing through to printing enables greater marketing analysis and hence better decision making

(IV) Ability to change card designs within the database means that designs shown to users can be altered without needing to adjust all digital marketing pages.

(V) Disaster Recovery—In the traditional scenario where all the cards are pre-printed there is an issue for Card Issuers in backup of these card stocks. As the lead time tends to be protracted, it is necessary to have excess card stock printed and housed in an offsite facility i.e. there are two sets of card stock in two separate card facilities. The facilities must have very similar or near identical functionality in regards to personalisation. This is clearly very expensive. The solution outlined here creates a built in disaster recovery solution in that if one facility goes offline the printing can be moved easily to a separate location simply by pulling (or pushing) the images to a separate location.

(VI) Redundancy—Also as printing hardware can breakdown it is very often necessary to have redundancy built in, i.e. to have two or more printers at any location. Again this is clearly an expensive option. Again by having a primary database it is easy to move the data to a new location if the printer is unavailable for scheduled or unscheduled maintenance.

The invention has been described with particular illustrative embodiments. It is to be understood that the invention is not limited to the above-described embodiments and that various changes and modifications may be made by those of ordinary skill in the art without departing from the scope of the invention.

1. A transaction card design creation apparatus comprising:
a processor for generating a first user interface configured to enable creation of a product type transaction card design for application to a transaction card, and storing the product type transaction card design in a first storage device; and
a processor for generating a second user interface configured to enable creation of a transaction card design comprising the product type transaction card design and at least one image, and storing the transaction card design in a second storage device.

2. The apparatus according to claim 1, wherein an unique product type transaction card design identifier is associated with the product type transaction card design.

3. The apparatus according to claim 2, wherein the first user interface is configured to enable amendment of the product type transaction card design, and wherein the amended product type transaction card design is associated with the unique product type transaction card design identifier.

4. The apparatus according to claim 1, wherein the first storage device comprises a plurality of product type transaction card designs, and wherein the second user interface is configured to enable selection of one of the plurality of product type transaction card designs.

5. The apparatus according to claim 1, wherein the product type transaction card design further comprises:
product type image data.

6. The apparatus according to claim 5, wherein the product type image data comprises information regarding at least one of the following: relative position; scale; orientation; opacity; pigments; inks; spot colours; metallic inks; tipping colours; BIN legends; coatings; text; text font size; text alphabet; text leading; text weighting; text spacing; text colour; and/or text position to be applied to the transaction card design.

7. The apparatus according to claim 1, wherein the second user interface comprises an image store and the image is uploaded to the image store.

8. The apparatus according to claim 1, wherein the second user interface comprises an image store and the image is selected from a plurality of images held in the image store.

9. The apparatus according to claim 1, wherein the image further comprises:
image manipulations data defining manipulations applied to the image.

10. The apparatus according to claim 9, wherein the image manipulations data comprises information regarding relative position; scale; orientation; text; opacity; pigments; inks; spot colours and/or metallic inks to be applied to the image.

11. The apparatus according to claim 1, further comprising:
a processor for generating a card personalisation facility interface configured to transfers the transaction card design from the second storage device to a card personalisation facility for printing onto a transaction card.

12. The apparatus according to claim 1, further comprising:
a transaction card design generator for generating a compiled transaction card design in one or more formats, based on the transaction card design.

13. The apparatus according to claim 12, wherein the one or more formats of the compiled transaction card design is stored in a compiled transaction card design storage device.

14. A method of creating a transaction card design comprising:
generating a first user interface configured to enable creation of a product type transaction card design for application to a transaction card, and storing the product type transaction card design in a first storage device; and
generating a second user interface configured to enable creation of a transaction card design comprising the product type transaction card design and at least one image, and storing the transaction card design in a second storage device.

15. A computer readable medium comprising computer readable code, said computer readable code configured to cause a computer to perform the following steps:
generate a first user interface configured to enable creation of a product type transaction card design for application to a transaction card, and storing the product type transaction card design in a first storage device; and
generate a second user interface configured to enable creation of a transaction card design comprising the product type transaction card design and at least one image, and storing the transaction card design in a second storage device.

16. An apparatus for printing a transaction card design onto a transaction card, the apparatus comprising:
a first database comprising a plurality of transaction card designs;
an internet communication link connecting the first database to a second database held in a secure environment, the second database comprising the plurality of transaction card designs, such that when a transaction card design is amended in the first database, the corresponding transaction card design is amended in the second database; and
a card personalisation facility interface configured to transfer a transaction card design from the second storage device to a card personalisation facility for printing onto a transaction card.

17. The system according to claim 16, wherein the card personalisation facility interface is configured to transfer printer data from the card personalisation facility to the second storage device.

18. The system according to claim 17, wherein the printer data comprise information regarding the number of transaction cards printed, the number of each transaction card design printed and/or the number of blank transaction cards available.

19. The system according to claim 16, wherein the card personalisation facility interface is configured to transfer alert data from the card personalisation facility to the second storage device when the number of blank transaction cards falls below a predetermined value.

20. The system according to claim 17, wherein the data is transferred from the second database to the first database via the internet communications link.

21. A transaction card design apparatus comprising:
a first storage device storing a transaction card design for application to a transaction card; and
a second storage device storing contents which replicate at least a portion of the contents of the first database, wherein the first and second storage device have a master and slave relationship, and the first database is the master.
